(19) United States
(12) Patent Application Publication
(10) Pub. No.: US 2019/0199921 A1
(43) Pub. Date: Jun. 27, 2019

(54) METHOD FOR TRANSMITTING 360-DEGREE VIDEO, METHOD FOR RECEIVING 360-DEGREE VIDEO, 360-DEGREE VIDEO TRANSMITTING DEVICE, AND 360-DEGREE VIDEO RECEIVING DEVICE

(71) Applicant: LG ELECTRONICS INC., Seoul (KR)

(72) Inventors: Sejin OH, Seoul (KR); Jongyeul SUH, Seoul (KR); Jangwon LEE, Seoul (KR)

(21) Appl. No.: 16/328,186

(22) PCT Filed: Jul. 10, 2017
(86) PCT No.: PCT/KR2017/007350

§ 371 Date: Feb. 25, 2019

Related U.S. Application Data
(60) Provisional application No. 62/380,978, filed on Aug. 29, 2016.
(60) Provisional application No. 62/401,844, filed on Sep. 29, 2016.
(60) Provisional application No. 62/444,378, filed on Jan. 10, 2017.

(51) Int. Cl. H04N 5/232; H04N 19/597; H04N 19/46; H04N 19/172

(52) U.S. Cl. CPC H04N 5/23238; H04N 19/172; H04N 19/46; H04N 19/597

(57) ABSTRACT

A method by which a 360-degree video transmission device transmits 360-degree video, according to the present invention, comprises the steps of: acquiring 360-degree video data captured by at least one camera; acquiring a projected picture by processing the 360-degree video data; acquiring a packed picture by applying a region-wise packing process to the projected picture; generating metadata for the 360-degree video data; encoding the packed picture; and performing processing for the storage or transmission of the encoded picture and the metadata, wherein the metadata includes 3D mapping information on a region of the packed picture, and the 3D mapping information indicates a yaw value and a pitch value of spherical coordinates of a spherical surface corresponding to a central point of the region.

### CROSS-REFERENCE TO RELATED APPLICATIONS

This application is the National Stage filing under 35 U.S.C. 371 of International Application No. PCT/KR2017/007350, filed on Jul. 10, 2017, which claims the benefit of U.S. Provisional Applications No. 62/380,978 filed on Aug. 29, 2016, No. 62/401,844 filed on Sep. 29, 2016 and No. 62/444,378 filed on Jan. 10, 2017, the contents of which are all hereby incorporated by reference herein in their entirety.

### BACKGROUND OF THE INVENTION

### Field of the Invention

The present invention relates to a 360-degree video and, more specifically, to methods and apparatus for transmitting and receiving a 360-degree video.

### Related Art

Virtual reality (VR) systems allow users to feel as if they are in electronically projected environments. Systems for providing VR can be improved in order to provide images with higher picture quality and spatial sounds. VR systems allow users to interactively consume VR content.

### SUMMARY OF THE INVENTION

An object of the present invention is to provide a method and apparatus for improving VR video data transmission efficiency for providing a VR system.

Another object of the present invention is to provide a method and apparatus for transmitting VR video data and metadata with respect to VR video data.

Another object of the present invention is to provide a method and apparatus for transmitting VR video data and metadata with respect to a VR video data projection and region-wise packing process.

According to an embodiment of the present invention, a 360 video processing method performed by a 360 video transmission apparatus is provided. The method includes: acquiring 360 video data captured by at least one camera; acquiring a projected picture by processing the 360 video data; acquiring a packed picture by applying region-wise packing to the projected picture; generating metadata for the 360 video data; encoding the packed picture; and performing processing for storage or transmission on the encoded picture and the metadata, wherein the metadata includes 3D mapping information on a region of the packed picture, and the 3D mapping information indicates a yaw value and a pitch value of spherical coordinates of a spherical surface corresponding to a center point of the region.

According to another embodiment of the present invention, a 360 video transmission apparatus for processing 360 video data is provided. The 360 video transmission apparatus includes: a data input unit for acquiring 360 video data captured by at least one camera; a projection processor for acquiring a projected picture by processing the 360 video data; a region-wise packing processor for acquiring a packed picture by applying region-wise packing to the projected picture; a metadata processor for generating metadata for the 360 video data; a data encoder for encoding the packed picture; and a transmission processor for performing processing for storage or transmission on the encoded picture and the metadata, wherein the metadata includes 3D mapping information on a region of the packed picture, and the 3D mapping information indicates a yaw value and a pitch value of spherical coordinates of a spherical surface corresponding to a center point of the region.

According to another embodiment of the present invention, a 360 video processing method performed by a 360 video reception apparatus is provided. The method includes: receiving a signal including information on a packed picture with respect to 360-degree video data and metadata with respect to the 360-degree video data; acquiring the information on the packed picture and the metadata by processing the signal; decoding the packed picture on the basis of the information on the packed picture; and rendering the decoded picture on a 3D space by processing the decoded picture on the basis of the metadata, wherein the metadata includes 3D mapping information on a region of the packed picture, and the 3D mapping information indicates a yaw value and a pitch value of spherical coordinates of a spherical surface corresponding to a center point of the region.

According to another embodiment of the present invention, a 360 video reception apparatus for processing 360 video data is provided. The 360 video reception apparatus includes: a receiver for receiving a signal including information on a packed picture with respect to 360-degree video data and metadata with respect to the 360-degree video data; a reception processor for acquiring the information on the packed picture and the metadata by processing the signal; a decoder for decoding the packed picture on the basis of the information on the packed picture; and a renderer for rendering the decoded picture on a 3D space by processing the decoded picture on the basis of the metadata, wherein the metadata includes 3D mapping information on a region of the packed picture, and the 3D mapping information indicates a yaw value and a pitch value of spherical coordinates of a spherical surface corresponding to a center point of the region.

According to the present invention, it is possible to efficiently transmit 360-degree content in an environment supporting next-generation hybrid broadcast using terrestrial broadcast networks and the Internet.

According to the present invention, it is possible to propose a method for providing interactive experience in 360-degree content consumption of users.

According to the present invention, it is possible to propose a signaling method for correctly reflecting the intention of a 360-degree content provider in 360-degree content consumption of users.

According to the present invention, it is possible to propose a method for efficiently increasing transmission capacity and forwarding necessary information in 360-degree content transmission.

According to the present invention, it is possible to transmit metadata with respect to a 360 video data projection and region-wise packing process, thereby improving transmission efficiency.

### BRIEF DESCRIPTION OF THE DRAWINGS

FIG. 1 is a view illustrating overall architecture for providing a 360 video according to the present invention.

FIGS. 2 and 3 are views illustrating a structure of a media file according to an embodiment of the present invention.

FIG. 4 illustrates an example of the overall operation of a DASH based adaptive streaming model.

FIG. 5 is a view schematically illustrating a configuration of a 360 video transmission apparatus to which the present invention is applicable.

FIG. 6 is a view schematically illustrating a configuration of a 360 video reception apparatus to which the present invention is applicable.

FIG. 7 illustrates an example of a spherical coordinate system in which 360 video data is represented as a spherical surface.

FIG. 8 is a view illustrating the concept of aircraft principal axes for describing a spherical surface representing a 360 video.

FIG. 9 illustrates a 2D image to which a 360 video processing process and a region-wise packing process according to projection scheme are applied.

FIG. 10 illustrates an example of projecting 360 video data on a 2D image through a cubic projection scheme.

FIG. 11 illustrates an example of projecting 360 video data on a 2D image through a cylindrical projection scheme.

FIG. 12 illustrates examples of 3D projection structures for an octahedral projection scheme and an icosahedral projection scheme.

FIG. 13 illustrates an example of metadata with respect to a projection and region-wise packing process when 360 video data is projected on the basis of a cubic projection scheme.

FIG. 14 illustrates types in which surfaces of cubes are arranged on a frame.

FIG. 15 illustrates flipped and mapped regions represented by a vertical_flipped field and a horizontal_flipped field.

FIG. 16 illustrates regions in a 3D space mapped to regions on a frame.

FIG. 17 illustrates an example of metadata with respect to a projection and region-wise packing process when 360 video data is projected on the basis of a cubic projection scheme.

FIG. 18 illustrates an example of metadata with respect to a projection and region-wise packing process when 360 video data is projected on the basis of a cylindrical projection scheme.

FIG. 19 illustrates types in which surfaces of cylinders are arranged on a frame.

FIG. 20 illustrates flipped and mapped regions represented by the vertical_flipped field and the horizontal_flipped field.

FIG. 21 illustrates an example of metadata with respect to a projection and region-wise packing process when 360 video data is projected on the basis of a cylindrical projection scheme.

FIG. 22 illustrates rotated and projected bottom regions represented on the basis of a rotation_axis field and a rotation_degree field.

FIG. 23 illustrates an example of metadata with respect to a projection and region-wise packing process when 360 video data is projected on the basis of a cylindrical projection scheme.

FIG. 24 illustrates metadata with respect to the projection and region-wise packing process.

FIG. 25 illustrates metadata with respect to a projection and region-wise packing process.

FIG. 26 illustrates OMVInformationSEIBox included and transmitted in VisualSampleEntry or HEVCSampleEntry.

FIG. 27 illustrates a method of signaling information about how a specific region has been packed when 360 video projected on the basis of a specific projection scheme is included in a file format.

FIGS. 28a to 28b illustrate an example of 360 video related metadata described in a DASH based descriptor format.

FIG. 29 schematically illustrates a 360 video data processing method performed by a 360 video transmission apparatus according to the present invention.

FIG. 30 schematically illustrates a 360 video data processing method performed by a 360 video reception apparatus according to the present invention.

### DESCRIPTION OF EXEMPLARY EMBODIMENTS

The present invention may be modified in various forms, and specific embodiments thereof will be described and illustrated in the drawings. However, the embodiments are not intended for limiting the invention. The terms used in the following description are used to merely describe specific embodiments, but are not intended to limit the invention. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

On the other hand, elements in the drawings described in the invention are independently drawn for the purpose of convenience for explanation of different specific functions, and do not mean that the elements are embodied by independent hardware or independent software. For example, two or more elements of the elements may be combined to form a single element, or one element may be divided into plural elements. The embodiments in which the elements are combined and/or divided belong to the invention without departing from the concept of the invention.

Hereinafter, preferred embodiments of the present invention will be described in more detail with reference to the attached drawings. Hereinafter, the same reference numbers will be used throughout this specification to refer to the same components and redundant description of the same component will be omitted.

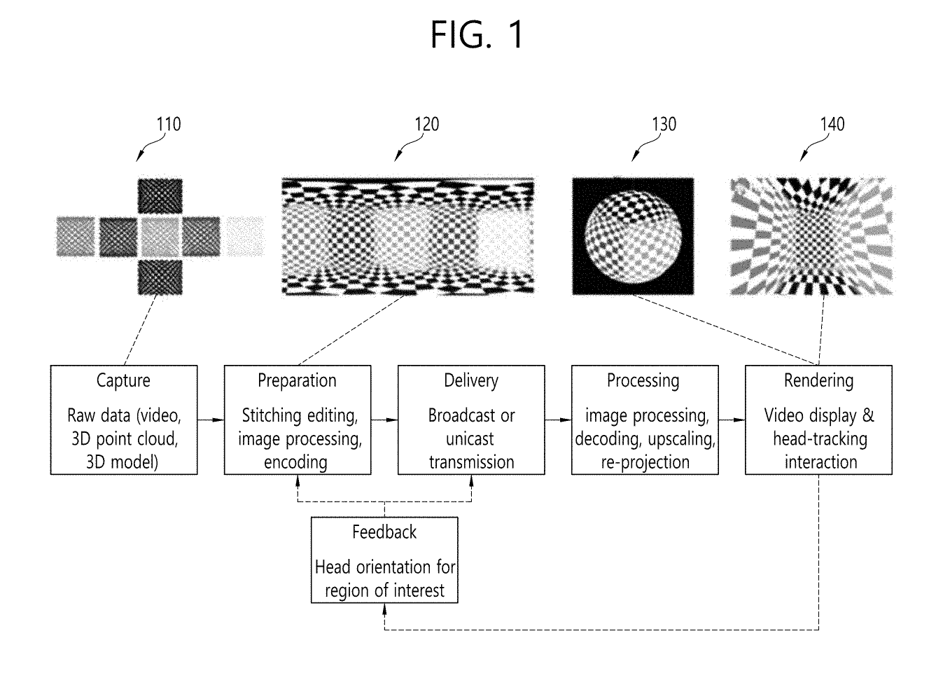

FIG. 1 is a view illustrating overall architecture for providing a 360-degree video according to the present invention.

The present invention proposes a method of providing 360-degree content in order to provide virtual reality (VR) to users. VR may refer to technology for replicating actual or virtual environments or those environments. VR artificially provides sensory experience to users and thus users can experience electronically projected environments.

360 content refers to content for realizing and providing VR and may include a 360 video and/or 360 audio. The 360 video may refer to video or image content which is necessary to provide VR and is captured or reproduced omnidirectionally (360 degrees). Hereinafter, the 360 video may refer to 360-degree video. A 360 video may refer to a video or an image represented on 3D spaces in various forms according to 3D models. For example, a 360 video can be represented on a spherical surface. The 360 audio is audio content for providing VR and may refer to spatial audio content whose audio generation source can be recognized to be located in a specific 3D space. 360 content may be generated, processed and transmitted to users and users can consume VR experiences using the 360 content.

Particularly, the present invention proposes a method for effectively providing a 360 video. To provide a 360 video, a 360 video may be captured through one or more cameras. The captured 360 video may be transmitted through series of processes and a reception side may process the transmitted 360 video into the original 360 video and render the 360 video. In this manner the 360 video can be provided to a user.

Specifically, processes for providing a 360 video may include a capture process, a preparation process, a transmission process, a processing process, a rendering process and/or a feedback process.

The capture process may refer to a process of capturing images or videos for a plurality of viewpoints through one or more cameras. Image/video data 110 shown in FIG. 1 may be generated through the capture process. Each plane of 110 in FIG. 1 may represent an image/video for each viewpoint. A plurality of captured images/videos may be referred to as raw data. Metadata related to capture can be generated during the capture process.

For capture, a special camera for VR may be used. When a 360 video with respect to a virtual space generated by a computer is provided according to an embodiment, capture through an actual camera may not be performed. In this case, a process of simply generating related data can substitute for the capture process.

The preparation process may be a process of processing captured images/videos and metadata generated in the capture process. Captured images/videos may be subjected to a stitching process, a projection process, a region-wise packing process and/or an encoding process during the preparation process.

First, each image/video may be subjected to the stitching process. The stitching process may be a process of connecting captured images/videos to generate one panorama image/video or spherical image/video.

Subsequently, stitched images/videos may be subjected to the projection process. In the projection process, the stitched images/videos may be projected on 2D image. The 2D image may be called a 2D image frame according to context. Projection on a 2D image may be referred to as mapping to a 2D image. Projected image/video data may have the form of a 2D image 120 in FIG. 1.

Video data projected on the 2D image may be subjected to the region-wise packing process in order to improve video coding efficiency. Region-wise packing may refer to a process of processing video data projected on a 2D image for each region. Here, regions may refer to divided areas of a 2D image. Regions can be obtained by dividing a 2D image equally or arbitrarily according to an embodiment. Further, regions may be divided according to a projection scheme in an embodiment. The region-wise packing process is an optional process and may be omitted in the preparation process.

The processing process may include a process of rotating regions or rearranging the regions on a 2D image in order to improve video coding efficiency according to an embodiment. For example, it is possible to rotate regions such that specific sides of regions are positioned in proximity to each other to improve coding efficiency.

The processing process may include a process of increasing or decreasing resolution for a specific region in order to differentiate resolutions for regions of a 360 video according to an embodiment. For example, it is possible to increase the resolution of regions corresponding to relatively more important regions in a 360 video to be higher than the resolution of other regions. Video data projected on the 2D image or region-wise packed video data may be subjected to the encoding process through a video codec.

According to an embodiment, the preparation process may further include an additional editing process. In this editing process, editing of image/video data before and after projection may be performed. In the preparation process, metadata regarding stitching/projection/encoding/editing may also be generated. Further, metadata regarding an initial viewpoint or a region of interest (ROI) of video data projected on the 2D image may be generated.

The transmission process may be a process of processing and transmitting image/video data and metadata which have passed through the preparation process. Processing according to an arbitrary transmission protocol may be performed for transmission. Data which has been processed for transmission may be delivered through a broadcast network and/or a broadband. Such data may be delivered to a reception side in an on-demand manner. The reception side may receive the data through various paths.

The processing process may refer to a process of decoding received data and re-projecting projected image/video data on a 3D model. In this process, image/video data projected on the 2D image may be re-projected on a 3D space. This process may be called mapping or projection according to context. Here, 3D model to which image/video data is mapped may have different forms according to 3D models. For example, 3D models may include a sphere, a cube, a cylinder and a pyramid.

According to an embodiment, the processing process may additionally include an editing process and an up-scaling process. In the editing process, editing of image/video data before and after re-projection may be further performed. When the image/video data has been reduced, the size of the image/video data can be increased by up-scaling samples in the up-scaling process. An operation of decreasing the size through down-scaling may be performed as necessary.

The rendering process may refer to a process of rendering and displaying the image/video data re-projected on the 3D space. Re-projection and rendering may be combined and represented as rendering on a 3D model. An image/video re-projected on a 3D model (or rendered on a 3D model) may have a form 130 shown in FIG. 1. The form 130 shown in FIG. 1 corresponds to a case in which the image/video is re-projected on a 3D spherical model. A user can view a region of the rendered image/video through a VR display. Here, the region viewed by the user may have a form 140 shown in FIG. 1.

The feedback process may refer to a process of delivering various types of feedback information which can be acquired in a display process to a transmission side. Interactivity in consumption of a 360 video can be provided through the feedback process. According to an embodiment, head orientation information, viewport information representing a region currently viewed by a user, and the like can be delivered to a transmission side in the feedback process. According to an embodiment, a user may interact with an object realized in a VR environment. In this case, information about the interaction may be delivered to a transmission side or a service provider in the feedback process. According to an embodiment, the feedback process may not be performed.

The head orientation information may refer to information about the position, angle, motion and the like of the head of a user. Based on this information, information about a region in a 360 video which is currently viewed by the user, that is, viewport information, can be calculated.

The viewport information may be information about a region in a 360 video which is currently viewed by a user. Gaze analysis may be performed through the viewpoint information to check how the user consumes the 360 video, which region of the 360 video is gazed by the user, how long the region is gazed, and the like. Gaze analysis may be performed at a reception side and a result thereof may be delivered to a transmission side through a feedback channel A device such as a VR display may extract a viewport region based on the position/direction of the head of a user, information on a vertical or horizontal field of view (FOV) supported by the device, and the like.

According to an embodiment, the aforementioned feedback information may be consumed at a reception side as well as being transmitted to a transmission side. That is, decoding, re-projection and rendering at the reception side may be performed using the aforementioned feedback information. For example, only a 360 video with respect to a region currently viewed by the user may be preferentially decoded and rendered using the head orientation information and/or the viewport information.

Here, a viewport or a viewport region may refer to a region in a 360 video being viewed by a user. A viewpoint is a point in a 360 video being viewed by a user and may refer to a center point of a viewport region. That is, a viewport is a region having a viewpoint at the center thereof, and the size and the shape of the region can be determined by an FOV which will be described later.

In the above-described overall architecture for providing a 360 video, image/video data which is subjected to the capture/projection/encoding/transmission/decoding/re-projection/rendering processes may be referred to as 360 video data. The term “360 video data” may be used as the concept including metadata and signaling information related to such image/video data.

To store and transmit media data such as the aforementioned audio and video data, a standardized media file format may be defined. According to an embodiment, a media file may have a file format based on ISO BMFF (ISO base media file format).

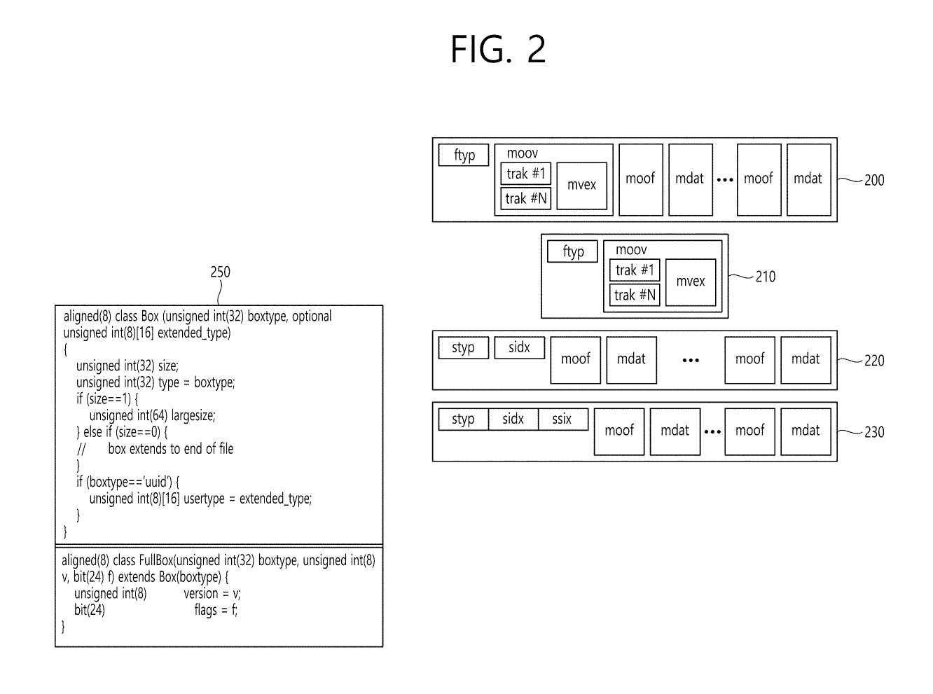

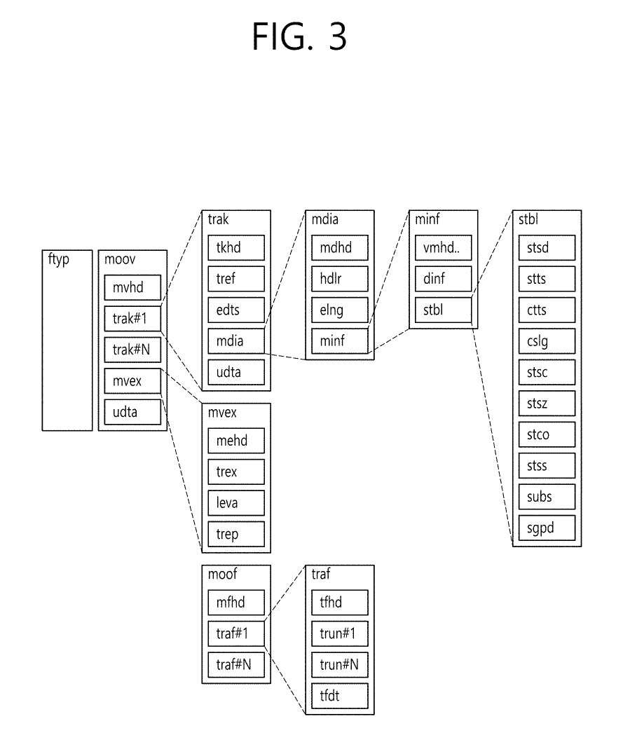

FIGS. 2 and 3 are views illustrating a structure of a media file according to an embodiment of the present invention.

The media file according to the present invention may include at least one box. Here, a box may be a data block or an object including media data or metadata related to media data. Boxes may be in a hierarchical structure and thus data can be classified and media files can have a format suitable for storage and/or transmission of large-capacity media data. Further, media files may have a structure which allows users to easily access media information such as moving to a specific point of media content.

The media file according to the present invention may include an ftyp box, a moov box and/or an mdat box.

The ftyp box (file type box) can provide file type or compatibility related information about the corresponding media file. The ftyp box may include configuration version information about media data of the corresponding media file. A decoder can identify the corresponding media file with reference to ftyp box.

The moov box (movie box) may be a box including metadata about media data of the corresponding media file. The moov box may serve as a container for all metadata. The moov box may be a highest layer among boxes related to metadata. According to an embodiment, only one moov box may be present in a media file.

The mdat box (media data box) may be a box containing actual media data of the corresponding media file. Media data may include audio samples and/or video samples. The mdat box may serve as a container containing such media samples.

According to an embodiment, the aforementioned moov box may further include an mvhd box, a trak box and/or an mvex box as lower boxes.

The mvhd box (movie header box) may include information related to media presentation of media data included in the corresponding media file. That is, the mvhd box may include information such as a media generation time, change time, time standard and period of corresponding media presentation.

The trak box (track box) can provide information about a track of corresponding media data. The trak box can include information such as stream related information, presentation related information and access related information about an audio track or a video track. A plurality of trak boxes may be present depending on the number of tracks.

The trak box may further include a tkhd box (track head box) as a lower box. The tkhd box can include information about the track indicated by the trak box. The tkhd box can include information such as a generation time, a change time and a track identifier of the corresponding track.

The mvex box (movie extend box) can indicate that the corresponding media file may have a moof box which will be described later. To recognize all media samples of a specific track, moof boxes may need to be scanned.

According to an embodiment, the media file according to the present invention may be divided into a plurality of fragments (200). Accordingly, the media file can be fragmented and stored or transmitted. Media data (mdat box) of the media file can be divided into a plurality of fragments and each fragment can include a moof box and a divided mdat box. According to an embodiment, information of the ftyp box and/or the moov box may be required to use the fragments.

The moof box (movie fragment box) can provide metadata about media data of the corresponding fragment. The moof box may be a highest-layer box among boxes related to metadata of the corresponding fragment.

The mdat box (media data box) can include actual media data as described above. The mdat box can include media samples of media data corresponding to each fragment corresponding thereto.

According to an embodiment, the aforementioned moof box may further include an mfhd box and/or a traf box as lower boxes.

The mfhd box (movie fragment header box) can include information about correlation between divided fragments. The mfhd box can indicate the order of divided media data of the corresponding fragment by including a sequence number. Further, it is possible to check whether there is missed data among divided data using the mfhd box.

The traf box (track fragment box) can include information about the corresponding track fragment. The traf box can provide metadata about a divided track fragment included in the corresponding fragment. The traf box can provide metadata such that media samples in the corresponding track fragment can be decoded/reproduced. A plurality of traf boxes may be present depending on the number of track fragments.

According to an embodiment, the aforementioned traf box may further include a tfhd box and/or a trun box as lower boxes.

The tfhd box (track fragment header box) can include header information of the corresponding track fragment. The tfhd box can provide information such as a basic sample size, a period, an offset and an identifier for media samples of the track fragment indicated by the aforementioned traf box.

The trun box (track fragment run box) can include information related to the corresponding track fragment. The trun box can include information such as a period, a size and a reproduction time for each media sample.

The aforementioned media file and fragments thereof can be processed into segments and transmitted. Segments may include an initialization segment and/or a media segment.

A file of the illustrated embodiment 210 may include information related to media decoder initialization except media data. This file may correspond to the aforementioned initialization segment, for example. The initialization segment can include the aforementioned ftyp box and/or moov box.

A file of the illustrated embodiment 220 may include the aforementioned fragment. This file may correspond to the aforementioned media segment, for example. The media segment may further include an styp box and/or an sidx box.

The styp box (segment type box) can provide information for identifying media data of a divided fragment. The styp box can serve as the aforementioned ftyp box for a divided fragment. According to an embodiment, the styp box may have the same format as the ftyp box.

The sidx box (segment index box) can provide information indicating an index of a divided fragment. Accordingly, the order of the divided fragment can be indicated.

According to an embodiment 230, an ssix box may be further included. The ssix box (sub-segment index box) can provide information indicating an index of a sub-segment when a segment is divided into sub-segments.

Boxes in a media file can include more extended information based on a box or a FullBox as shown in the illustrated embodiment 250. In the present embodiment, a size field and a largesize field can represent the length of the corresponding box in bytes. A version field can indicate the version of the corresponding box format. A type field can indicate the type or identifier of the corresponding box. A flags field can indicate a flag associated with the corresponding box.

Meanwhile, the fields (attributes) for 360 video of the present invention can be included and delivered in a DASH based adaptive streaming model.

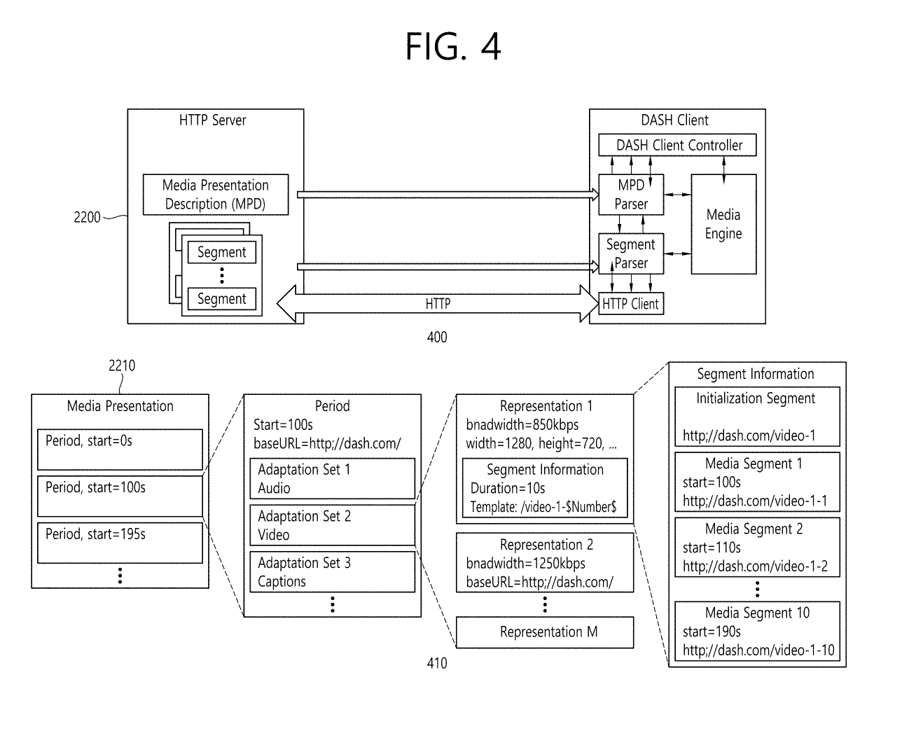

FIG. 4 illustrates an example of the overall operation of a DASH based adaptive streaming model. The DASH based adaptive streaming model according to the illustrated embodiment 400 describes operations between an HTTP server and a DASH client. Here, DASH (Dynamic Adaptive Streaming over HTTP) is a protocol for supporting adaptive streaming based on HTTP and can dynamically support streaming according to network state. Accordingly, seamless AV content reproduction can be provided.

First, a DASH client can acquire an MPD. The MPD can be delivered from a service provider such as an HTTP server. The DASH client can send a request for corresponding segments to the server using information on access to the segments which is described in the MPD. Here, the request can be performed based on a network state.

Upon acquisition of the segments, the DASH client can process the segments in a media engine and display the processed segments on a screen. The DASH client can request and acquire necessary segments by reflecting a reproduction time and/or a network state therein in real time (adaptive streaming). Accordingly, content can be seamlessly reproduced.

The MPD (Media Presentation Description) is a file including detailed information for a DASH client to dynamically acquire segments and can be represented in the XML format.

A DASH client controller can generate a command for requesting the MPD and/or segments based on a network state. Further, this controller can control an internal block such as the media engine to be able to use acquired information.

An MPD parser can parse the acquired MPD in real time. Accordingly, the DASH client controller can generate the command for acquiring necessary segments.

The segment parser can parse acquired segments in real time. Internal blocks such as the media block can perform specific operations according to information included in the segments.

An HTTP client can send a request for a necessary MPD and/or segments to the HTTP server. In addition, the HTTP client can transfer the MPD and/or segments acquired from the server to the MPD parser or a segment parser.

The media engine can display content on a screen using media data included in segments. Here, information of the MPD can be used.

A DASH data model may have a hierarchical structure 410. Media presentation can be described by the MPD. The MPD can describe a temporal sequence of a plurality of periods which forms the media presentation. A period can represent one period of media content.

In one period, data can be included in adaptation sets. An adaptation set may be a set of a plurality of exchangeable media content components. Adaptation can include a set of representations. A representation can correspond to a media content component. Content can be temporally divided into a plurality of segments within one representation. This may be for accessibility and delivery. To access each segment, the URL of each segment may be provided.

The MPD can provide information related to media presentation, and a period element, an adaptation set element and a representation element can respectively describe the corresponding period, adaptation set and representation. A representation can be divided into sub-representations, and a sub-representation element can describe the corresponding sub-representation.

Here, common attributes/elements can be defined. The common attributes/elements can be applied to (included in) adaptation sets, representations and sub-representations. The common attributes/elements may include an essential property and/or a supplemental property.

The essential property is information including elements regarded as essential elements in processing data related to the corresponding media presentation. The supplemental property is information including elements which may be used to process data related to the corresponding media presentation. According to an embodiment, when descriptors which will be described later are delivered through the MPD, the descriptors can be defined in the essential property and/or the supplemental property and delivered.

FIG. 4 is a view schematically illustrating a configuration of a 360 video transmission apparatus to which the present invention is applicable.

The 360 video transmission apparatus according to the present invention can perform operations related the above-described preparation process and the transmission process. The 360 video transmission apparatus may include a data input unit, a stitcher, a projection processor, a region-wise packing processor (not shown), a metadata processor, a (transmission side) feedback processor, a data encoder, an encapsulation processor, a transmission processor and/or a transmitter as internal/external elements.

The data input unit can receive captured images/videos for respective viewpoints. The images/videos for the respective viewpoints may be images/videos captured by one or more cameras. Further, data input unit may receive metadata generated in a capture process. The data input unit may forward the received images/videos for the viewpoints to the stitcher and forward metadata generated in the capture process to the signaling processor.

The stitcher can perform a stitching operation on the captured images/videos for the viewpoints. The stitcher may forward stitched 360 video data to the projection processor. The stitcher may receive necessary metadata from the metadata processor and use the metadata for the stitching operation as necessary. The stitcher may forward metadata generated in the stitching process to the metadata processor. The metadata in the stitching process may include information such as information representing whether stitching has been performed, and a stitching type.

The projection processor can project the stitched 360 video data on a 2D image. The projection processor may perform projection according to various schemes which will be described later. The projection processor may perform mapping in consideration of the depth of 360 video data for each viewpoint. The projection processor may receive metadata necessary for projection from the metadata processor and use the metadata for the projection operation as necessary. The projection processor may forward metadata generated in the projection process to the metadata processor. Metadata generated in the projection processor may include a projection scheme type and the like.

The region-wise packing processor (not shown) can perform the aforementioned region-wise packing process. That is, the region-wise packing processor can perform the process of dividing the projected 360 video data into regions and rotating and rearranging regions or changing the resolution of each region. As described above, the region-wise packing process is optional and thus the region-wise packing processor may be omitted when region-wise packing is not performed. The region-wise packing processor may receive metadata necessary for region-wise packing from the metadata processor and use the metadata for a region-wise packing operation as necessary. The region-wise packing processor may forward metadata generated in the region-wise packing process to the metadata processor. Metadata generated in the region-wise packing processor may include a rotation degree, size and the like of each region.

The aforementioned stitcher, projection processor and/or the region-wise packing processor may be integrated into a single hardware component according to an embodiment.

The metadata processor can process metadata which may be generated in a capture process, a stitching process, a projection process, a region-wise packing process, an encoding process, an encapsulation process and/or a process for transmission. The metadata processor can generate 360 video related metadata using such metadata. According to an embodiment, the metadata processor may generate the 360 video related metadata in the form of a signaling table. 360 video related metadata may also be called metadata or 360 video related signaling information according to signaling context. Further, the metadata processor may forward the acquired or generated metadata to internal elements of the 360 video transmission apparatus as necessary. The metadata processor may forward the 360 video related metadata to the data encoder, the encapsulation processor and/or the transmission processor such that the 360 video related metadata can be transmitted to a reception side.

The data encoder can encode the 360 video data projected on the 2D image and/or region-wise packed 360 video data. The 360 video data can be encoded in various formats.

The encapsulation processor can encapsulate the encoded 360 video data and/or 360 video related metadata in a file format. Here, the 360 video related metadata may be received from the metadata processor. The encapsulation processor can encapsulate the data in a file format such as ISOBMFF, CFF or the like or process the data into a DASH segment or the like. The encapsulation processor may include the 360 video related metadata in a file format. The 360 video related metadata may be included in a box having various levels in SOBMFF or may be included as data of a separate track in a file, for example. According to an embodiment, the encapsulation processor may encapsulate the 360 video related metadata into a file. The transmission processor may perform processing for transmission on the encapsulated 360 video data according to file format. The transmission processor may process the 360 video data according to an arbitrary transmission protocol. The processing for transmission may include processing for delivery over a broadcast network and processing for delivery over a broadband. According to an embodiment, the transmission processor may receive 360 video related metadata from the metadata processor as well as the 360 video data and perform the processing for transmission on the 360 video related metadata.

The transmitter can transmit the 360 video data and/or the 360 video related metadata processed for transmission through a broadcast network and/or a broadband. The transmitter may include an element for transmission through a broadcast network and/or an element for transmission through a broadband.

According to an embodiment of the 360 video transmission apparatus according to the present invention, the 360 video transmission apparatus may further include a data storage unit (not shown) as an internal/external element. The data storage unit may store encoded 360 video data and/or 360 video related metadata before the encoded 360 video data and/or 360 video related metadata are delivered to the transmission processor. Such data may be stored in a file format such as ISOBMFF. Although the data storage unit may not be required when 360 video is transmitted in real time, encapsulated 360 data may be stored in the data storage unit for a certain period of time and then transmitted when the encapsulated 360 data is delivered over a broadband.

According to another embodiment of the 360 video transmission apparatus according to the present invention, the 360 video transmission apparatus may further include a (transmission side) feedback processor and/or a network interface (not shown) as internal/external elements. The network interface can receive feedback information from a 360 video reception apparatus according to the present invention and forward the feedback information to the transmission side feedback processor. The transmission side feedback processor can forward the feedback information to the stitcher, the projection processor, the region-wise packing processor, the data encoder, the encapsulation processor, the metadata processor and/or the transmission processor. According to an embodiment, the feedback information may be delivered to the metadata processor and then delivered to each internal element. Internal elements which have received the feedback information can reflect the feedback information in the following 360 video data processing.

According to another embodiment of the 360 video transmission apparatus according to the present invention, the region-wise packing processor may rotate regions and map the rotated regions on a 2D image. Here, the regions may be rotated in different directions at different angles and mapped on the 2D image. Region rotation may be performed in consideration of neighboring parts and stitched parts of 360 video data on a spherical surface before projection. Information about region rotation, that is, rotation directions, angles and the like may be signaled through 360 video related metadata. According to another embodiment of the 360 video transmission apparatus according to the present invention, the data encoder may perform encoding differently for respective regions. The data encoder may encode a specific region in high quality and encode other regions in low quality. The transmission side feedback processor may forward feedback information received from the 360 video reception apparatus to the data encoder such that the data encoder can use encoding methods differentiated for respective regions. For example, the transmission side feedback processor may forward viewport information received from a reception side to the data encoder. The data encoder may encode regions including an area indicated by the viewport information in higher quality (UHD and the like) than that of other regions.

According to another embodiment of the 360 video transmission apparatus according to the present invention, the transmission processor may perform processing for transmission differently for respective regions. The transmission processor may apply different transmission parameters (modulation orders, code rates, and the like) to the respective regions such that data delivered to the respective regions have different robustnesses.

Here, the transmission side feedback processor may forward feedback information received from the 360 video reception apparatus to the transmission processor such that the transmission processor can perform transmission processes differentiated for respective regions. For example, the transmission side feedback processor may forward viewport information received from a reception side to the transmission processor. The transmission processor may perform a transmission process on regions including an area indicated by the viewport information such that the regions have higher robustness than other regions.

The above-described internal/external elements of the 360 video transmission apparatus according to the present invention may be hardware elements. According to an embodiment, the internal/external elements may be changed, omitted, replaced by other elements or integrated.

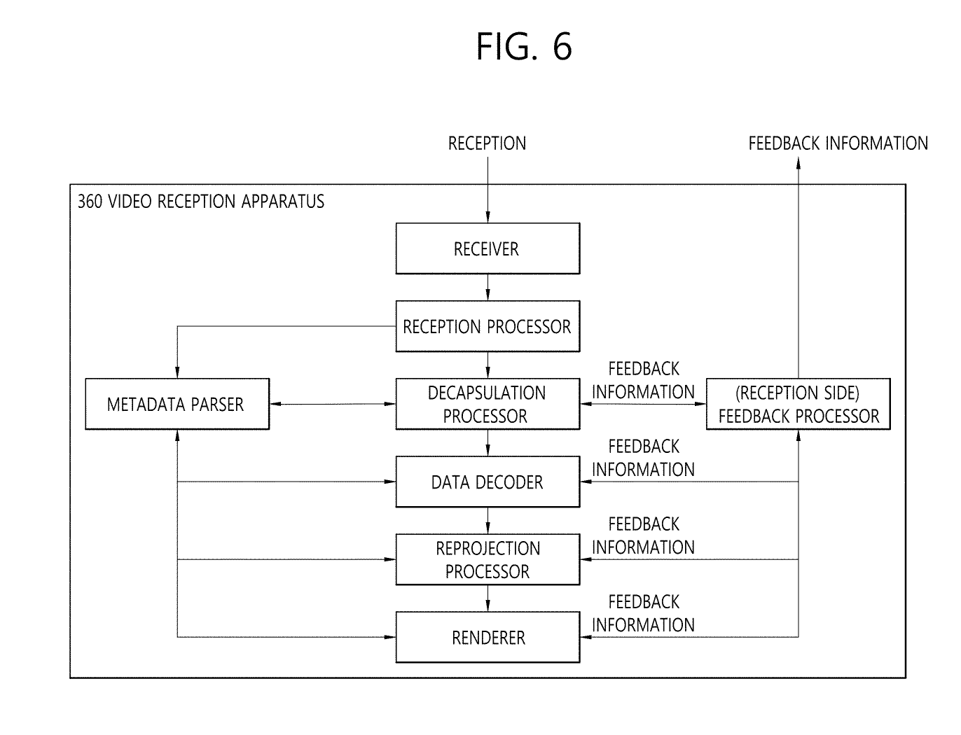

FIG. 6 is a view schematically illustrating a configuration of a 360 video reception apparatus to which the present invention is applicable.

The 360 video reception apparatus according to the present invention can perform operations related to the above-described processing process and/or the rendering process. The 360 video reception apparatus may include a receiver, a reception processor, a decapsulation processor, a data decoder, a metadata parser, a (reception side) feedback processor, a re-projection processor and/or a renderer as internal/external elements. A signaling parser may be called the metadata parser.

The receiver can receive 360 video data transmitted from the 360 video transmission apparatus according to the present invention. The receiver may receive the 360 video data through a broadcast network or a broadband depending on a channel through which the 360 video data is transmitted.

The reception processor can perform processing according to a transmission protocol on the received 360 video data. The reception processor may perform a reverse process of the process of the aforementioned transmission processor such that the reverse process corresponds to processing for transmission performed at the transmission side. The reception processor can forward the acquired 360 video data to the decapsulation processor and forward acquired 360 video related metadata to the metadata parser. The 360 video related metadata acquired by the reception processor may have the form of a signaling table.

The decapsulation processor can decapsulate the 360 video data in a file format received from the reception processor. The decapsulation processor can acquired 360 video data and 360 video related metadata by decapsulating files in ISOBMFF or the like. The decapsulation processor can forward the acquired 360 video data to the data decoder and forward the acquired 360 video related metadata to the metadata parser. The 360 video related metadata acquired by the decapsulation processor may have the form of a box or a track in a file format. The decapsulation processor may receive metadata necessary for decapsulation from the metadata parser as necessary.

The data decoder can decode the 360 video data. The data decoder may receive metadata necessary for decoding from the metadata parser. The 360 video related metadata acquired in the data decoding process may be forwarded to the metadata parser.

The metadata parser can parse/decode the 360 video related metadata. The metadata parser can forward acquired metadata to the data decapsulation processor, the data decoder, the re-projection processor and/or the renderer.

The re-projection processor can perform re-projection on the decoded 360 video data. The re-projection processor can re-project the 360 video data on a 3D space. The 3D space may have different forms depending on 3D models. The re-projection processor may receive metadata necessary for re-projection from the metadata parser. For example, the re-projection processor may receive information about the type of a used 3D model and detailed information thereof from the metadata parser. According to an embodiment, the re-projection processor may re-project only 360 video data corresponding to a specific area of the 3D space on the 3D space using metadata necessary for re-projection.

The renderer can render the re-projected 360 video data. As described above, re-projection of 360 video data on a 3D space may be represented as rendering of 360 video data on the 3D space. When two processes simultaneously occur in this manner, the re-projection processor and the renderer may be integrated and the renderer may perform the processes. According to an embodiment, the renderer may render only a part viewed by a user according to viewpoint information of the user.

The user may view a part of the rendered 360 video through a VR display or the like. The VR display is a device which reproduces 360 video and may be included in a 360 video reception apparatus (tethered) or connected to the 360 video reception apparatus as a separate device (un-tethered).

According to an embodiment of the 360 video reception apparatus according to the present invention, the 360 video reception apparatus may further include a (reception side) feedback processor and/or a network interface (not shown) as internal/external elements. The reception side feedback processor can acquire feedback information from the renderer, the re-projection processor, the data decoder, the decapsulation processor and/or the VR display and process the feedback information. The feedback information may include viewport information, head orientation information, gaze information, and the like. The network interface can receive the feedback information from the reception side feedback processor and transmit the feedback information to a 360 video transmission apparatus.

As described above, the feedback information may be consumed at the reception side as well as being transmitted to the transmission side. The reception side feedback processor may forward the acquired feedback information to internal elements of the 360 video reception apparatus such that the feedback information is reflected in processes such as rendering. The reception side feedback processor can forward the feedback information to the renderer, the re-projection processor, the data decoder and/or the decapsulation processor. For example, the renderer can preferentially render an area viewed by the user using the feedback information. In addition, the decapsulation processor and the data decoder can preferentially decapsulate and decode an area being viewed or will be viewed by the user.

The above-described internal/external elements of the 360 video reception apparatus according to the present invention may be hardware elements. According to an embodiment, the internal/external elements may be changed, omitted, replaced by other elements or integrated. According to an embodiment, additional elements may be added to the 360 video reception apparatus.

Another aspect of the present invention may pertain to a method for transmitting a 360 video and a method for receiving a 360 video. The methods for transmitting/receiving a 360 video according to the present invention may be performed by the above-described 360 video transmission/reception apparatuses or embodiments thereof.

Embodiments of the above-described 360 video transmission/reception apparatuses and transmission/reception methods and embodiments of the internal/external elements of the apparatuses may be combined. For example, embodiments of the projection processor and embodiments of the data encoder may be combined to generate as many embodiments of the 360 video transmission apparatus as the number of cases. Embodiments combined in this manner are also included in the scope of the present invention.

Meanwhile, the aforementioned 360 video may be represented as a spherical surface of a 3D space and each point on the spherical surface may be represented as follows.

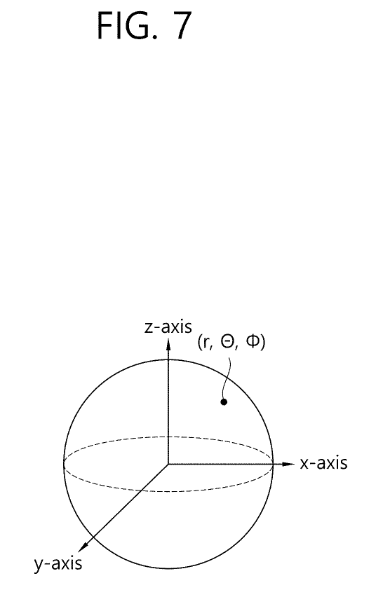

FIG. 7 illustrates an example of a spherical coordinate system in which 360 video data is represented as a spherical surface. 360 video data acquired from a camera can be represented as a spherical surface. As shown in FIG. 7, each point on the spherical surface can be represented by r (the radius of a sphere), θ (rotation direction and degree based on a z axis) and φ (rotation direction and degree to the z axis of an x-y plane) using the spherical coordinate system. According to an embodiment, the spherical surface may be consistent with the world coordinate system or a principal point of a front camera may be assumed to be a point (r, 0, 0) of the spherical surface.

Meanwhile, the position of each point on the spherical surface may be represented on the basis of aircraft principal axes. For example, the position of each point on the spherical surface may be represented using a pitch, a yaw and a roll.

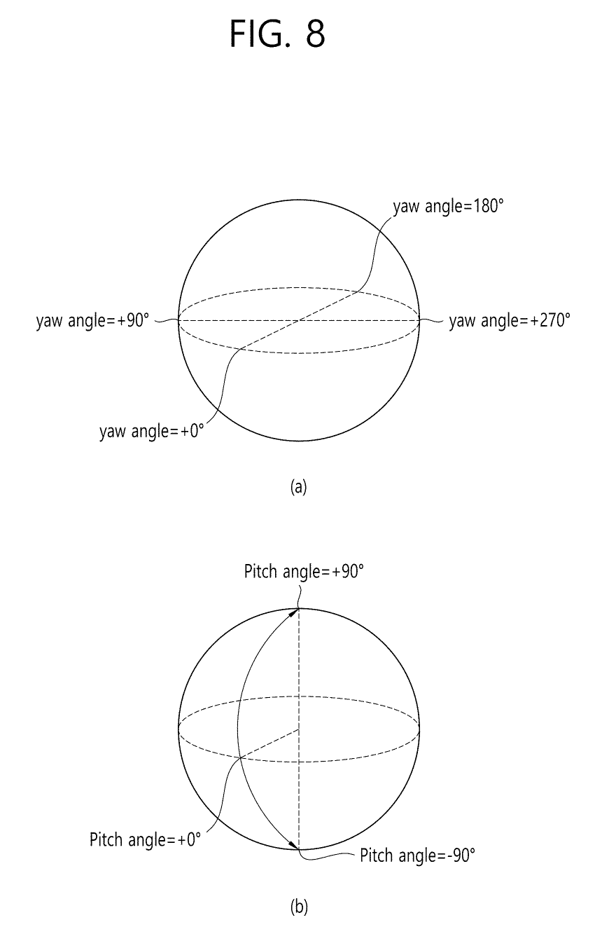

FIG. 8 illustrates the concept of the aircraft principal axes for describing a spherical surface representing a 360 video. In the present invention, the concept of the aircraft principal axes can be used to represent a specific point, position, direction, distance, region and the like in a 3D space. That is, the concept of the aircraft principal axes can be used to describe a 3D space before projection or after re-projection and perform signaling thereabout in the present invention. Axes forming 3D can be regarded as a pitch axis, a yaw axis and a roll axis. These may be represented as a pitch, a raw and a roll or a pitch direction, a yaw direction and a roll direction in the specification. Compared to XYZ coordinates, the pitch axis can correspond to the X axis, the yaw axis can correspond to the Z axis and the roll axis can correspond to the Y axis.

Referring to FIG. 8(a), a yaw angle can represent a rotation direction and degree on the basis of the yaw axis and the range of the yaw angle can be 0 to +360 degrees or −180 to +180 degrees. Referring to FIG. 8(b), a pitch angle can represent a rotation direction and degree on the basis of the pitch axis and the range of the pitch angle can be 0 to +180 degrees or −90 to +90 degrees. A roll angle can represent a rotation direction and degree on the basis of the roll axis and the range of the roll angle can be 0 to +360 degrees or −180 to +180 degrees. In the following description, the yaw angle increases clockwise and the range of the yaw angle can be assumed to be 0 to 360 degrees. Further, the pitch angle increases with decreasing distance from the Arctic and the range of the Arctic angle can be assumed to be −90 to +90 degrees.

Meanwhile, region-wise packing can be performed on video data projected on a 2D image in order to improve video coding efficiency, as described above. The region-wise packing process may refer to a process of dividing video data projected on a 2D image into regions and processing the regions. A region can represent a divided region of a 2D image on which 360 video data has been projected, and divided regions of the 2D image may be classified according to projection schemes. Here, the 2D image may be called a video frame or a frame.

In this regard, the present invention proposes metadata with respect to the region-wise packing process according to projection scheme and a metadata signaling method. The region-wise packing process can be performed more efficiently on the basis of the metadata.

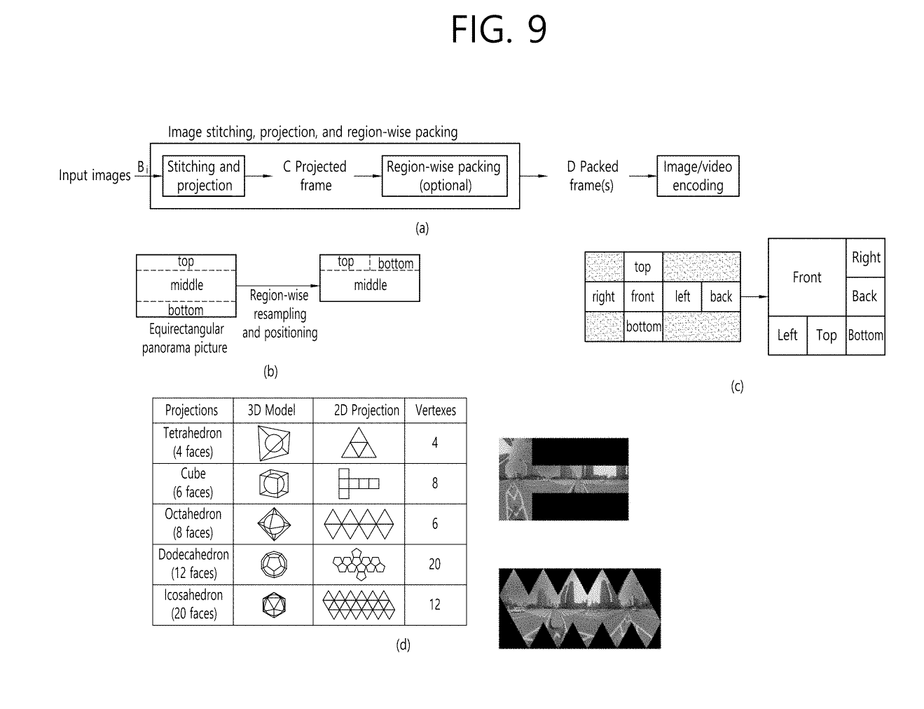

FIG. 9 illustrates a 2D image to which a 360 video processing process and a region-wise packing process according to projection scheme are applied. FIG. 9(a) shows a process of processing input 360 video data. Referring to FIG. 9(a), the input 360 video data can be stitched and projected on a 3D projection structure according to various projection schemes and the 360 video data projected on the 3D projection structure can be represented as a 2D image. That is, the 360 video data can be stitched and projected into the 2D image. The 2D image into which the 360 video data has been projected may be referred to as a projected frame. Further, the aforementioned region-wise packing process can be performed on the projected frame. That is, a process of dividing an area including the 360 video data projected into the projected frame into regions, rotating and rearranging each region or changing the resolution of each region may be performed. In other words, the region-wise packing process can refer to a process of mapping the projected frame to one or more packed frames. The region-wise packing process may be optional. When the region-wise packing process is not applied, the packed frame can be the same as the projected frame. When the region-wise packing process is applied, each region of the projected frame can be mapped to a region of the packed frame and metadata representing the position, shape and size of a region of the packed frame to which each region of the projected frame is mapped.

FIGS. 9(b) and 9(c) show examples in which each region of the projected frame is mapped to a region of the packed frame. Referring to FIG. 9(b), the 360 video data can be projected into a 2D image (or frame) according to a panoramic projection scheme. The top region, middle region and bottom region of the projected frame can be rearranged as shown in the right figure according to the region-wise packing process applied thereto. Here, the top region may be a region representing the top of the panorama in the 2D image, the middle region may be a region representing the middle of the panorama in the 2D image and the bottom region may be a region representing the bottom of the panorama in the 2D. Referring to FIG. 9(c), the 360 video data can be projected into a 2D image (or frame) according to a cubic projection scheme. The front region, back region, top region, bottom region, right region and left region of the projected frame can be rearranged as shown in the right figure according to the region-wise packing process applied thereto. Here, the front region may be a region representing the front of the cube in the 2D image and the back region may be a region representing the back of the cube in the 2D image. Further, the top region may be region representing the top of the cube in the 2D image and the bottom region may be a region representing the bottom of the cube in the 2D image. Further, the right region may be region representing the right side of the cube in the 2D image and the left region may be a region representing the left side of the cube in the 2D image.

FIG. 9(d) shows various 3D projection structures in which the 360 video data can be projected. Referring to FIG. 9(d), the 3D projection structures may include a tetrahedron, a cube, an octahedron, a dodecahedron and an icosahedron. The 2D projections shown in FIG. 9(d) can represent projected frames that represent 360 video data projected in the 3D projection structures as 2D images.

Specific embodiments of a method of deriving a projected frame on the basis of the above-described various projection schemes and a method of applying the region-wise packing process may be as follows.

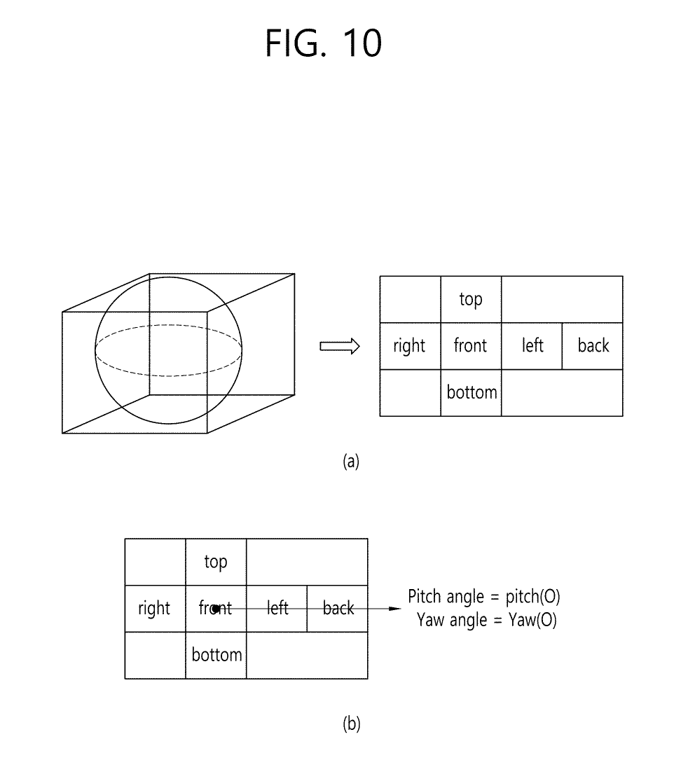

FIG. 10 shows an example of projecting 360 video data on a 2D image through the cubic projection scheme. Referring to FIG. 10, the 360 video data can be projected on the basis of the cubic projection scheme. For example, stitched 360 video data can be represented on a spherical surface and the 360 video data can be divided and projected on a 2D image in a cubic 3D projection structure. That is, the 360 video data on the spherical surface can be mapped to the surfaces of a cube and each surface of the cube can be projected on a 2D image, as shown on the right of FIG. 10(a). In this case, a point on the spherical surface which is a reference of projection can be represented as a reference point and the pitch angle of the reference point can be represented as Pitch(0) and the yaw angle thereof can be represented as Yaw(0). Pitch(0) and Yaw(0) may have 0 degrees or other angle values. Here, yaw angles indicating points on the spherical surface may be in a range of 0 to 360 degrees and yaw angle values may increase clockwise and decrease counterclockwise. Further, pitch angles may be in a range of −90 to 90 degrees and pitch angle values may increase with decreasing distance from the Arctic and decrease with decreasing distance from the Antarctic.

Referring to FIG. 10(b), the center pixel of the front region of the 2D image can be mapped (or matched) to the reference point. The front region can be represented as cube_front. The front region can represent a region whose center pixel is matched to the reference point of the 360 video as shown in FIG. 10(b). Alternatively, the front region may represent a region including a pixel mapped to the reference point.

Further, the right region of the 2D image may be represented as cube_right. The right region can represent a region whose center pixel is mapped to a point at which the pitch angle of the 360 video is Pitch(0) and the yaw angle is Yaw(0)+90. Alternatively, the right region can represent a region including a pixel mapped to the point at which the pitch angle is Pitch(0) and the yaw angle is Yaw(0)+90.

Further, the back region of the 2D image may be represented as cube_back. The back region can represent a region whose center pixel is mapped to a point at which the pitch angle of the 360 video is Pitch(0) and the yaw angle is Yaw(0)+180 or Yaw(0)−180. Alternatively, the back region can represent a region including a pixel mapped to the point at which the pitch angle is Pitch(0) and the yaw angle is Yaw(0)+180 or Yaw(0)−180.

Further, the left region of the 2D image may be represented as cube_left. The left region can represent a region whose center pixel is mapped to a point at which the pitch angle of the 360 video is Pitch(0) and the yaw angle is Yaw(0)+270 or Yaw(0)−90. Alternatively, the left region can represent a region including a pixel mapped to the point at which the pitch angle is Pitch(0) and the yaw angle is Yaw(0)+270 or Yaw(0)−90.

Further, the top region of the 2D image may be represented as cube_top. The top region can represent a region whose center pixel is mapped to a point at which the pitch angle of the 360 video is Pitch(0)+90 and the yaw angle is Yaw(0). Alternatively, the top region can represent a region including a pixel mapped to the point at which the pitch angle is Pitch(0)+90 and the yaw angle is Yaw(0).

Further, the bottom region of the 2D image may be represented as cube_bottom. The bottom region can represent a region whose center pixel is mapped to a point at which the pitch angle of the 360 video is Pitch(0)−90 and the yaw angle is Yaw(0). Alternatively, the bottom region can represent a region including a pixel mapped to the point at which the pitch angle is Pitch(0)−90 and the yaw angle is Yaw(0).

Although the 360 video data can be projected on the basis of the cubic projection scheme as described above, the 360 video data may be projected on the basis of a cylindrical projection scheme. Specific embodiments of a method of deriving a projected frame on the basis of the cylindrical projection scheme and a method of applying the region-wise packing process may be as follows.

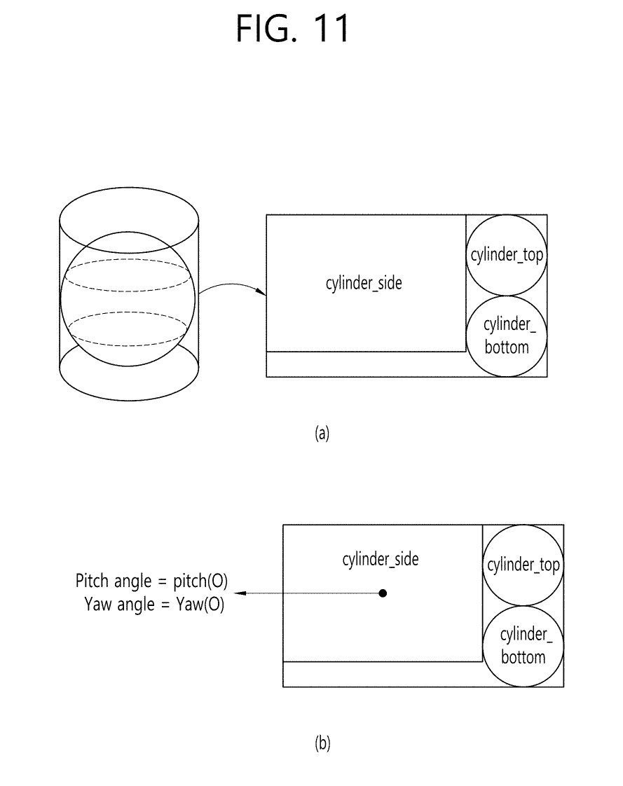

FIG. 11 shows an example of projecting 360 video data into a 2D image through the cylindrical projection scheme. Referring to FIG. 11, the 360 video data can be projected on the basis of the cylindrical projection scheme. For example, stitched 360 video data can be represented on a spherical surface, and the 360 video data can be projected on a 2D image in a cylindrical 3D projection structure. That is, the 360 video data on the spherical surface can be mapped to the surfaces of a cylinder and each surface of the cylinder can be projected on the 2D image, as shown on the right of FIG. 11(a). In this case, a point on the spherical surface which is a reference of projection may be referred to as a reference point and the pitch angle of the reference point may be represented as Pitch(0) and the yaw angle thereof may be represented as Yaw(0). Pitch(0) and Yaw(0) may be 0 degrees or other angle values. Here, yaw angles indicating positions on the spherical surface may be in a range of 0 to 360 degrees, and a yaw angle value can increase clockwise and decrease counterclockwise. Further, pitch angles may be in a range of −90 to 90, and a pitch angle value can increase with decreasing distance from the Arctic and decrease with decreasing distance from the Antarctic.

Referring to FIG. 11(b), the center pixel of the side region of the 2D image may be mapped (or matched) to the reference point. The side region may be represented as cylinder_side. The side region can represent a region whose center pixel is matched to the reference point of the 360 video, as shown in FIG. 11(b). Alternatively, the side region may represent a region including a pixel mapped to the reference point.

In addition, the top region of the 2D image may be represented as cylinder_top. The top region can represent a region whose center pixel is matched to a point at which the pitch angle of the 360 video is Pitch(0)+90 and the yaw angle is Yaw(0). Alternatively, the top side may represent a region including a pixel mapped to the point at which the pitch angle of the 360 video is Pitch(0)+90 and the yaw angle is Yaw(0).

Further, the bottom region of the 2D image may be represented as cylinder_bottom. The bottom region can represent a region whose center pixel is matched to a point at which the pitch angle of the 360 video is Pitch(0)−90 and the yaw angle is Yaw(0). Alternatively, the top side may represent a region including a pixel mapped to the point at which the pitch angle of the 360 video is Pitch(0)−90 and the yaw angle is Yaw(0).

Meanwhile, 360 video data may be projected on the basis of a projection scheme having an octahedron 3D projection structure or a projection scheme having an icosahedron 3D projection structure. A projection scheme having an octahedron 3D projection structure may be called an octahedral projection scheme and a projection scheme having an icosahedron 3D projection structure may be called an icosahedral projection scheme.

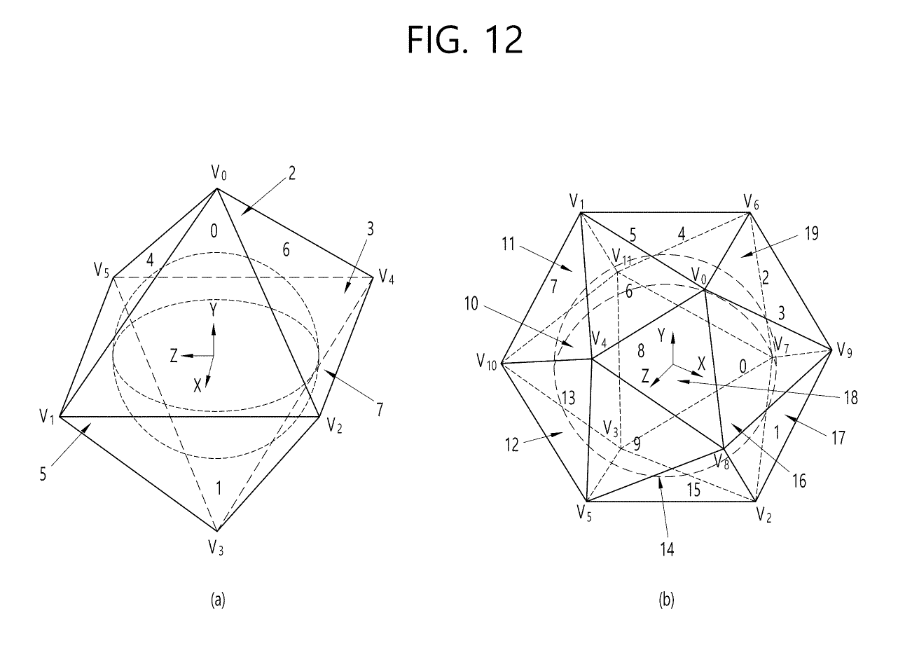

FIG. 12 shows examples of 3D projection structures with respect to an octahedral projection scheme and an icosahedral projection scheme. The aforementioned 360 video data can be projected on the basis of the octahedral projection scheme or the icosahedral projection scheme. FIG. 12(a) shows a 3D projection structure with respect to the octahedral projection scheme. The octahedral 3D projection structure can be defined by 6 vertexes and 8 faces and regions representing the 8 faces can have regular triangular forms having the same size. The vertexes may be represented by V0 to V5 and the faces may be represented by F0 to F7. In addition, the positions of the vertexes represented in the XYZ coordinates may be defined as shown in the following table.

TABLE 1

| Vertex | f |
|---|---|
| V0 | (0, 2^{0.5}, 0) |
| V1 | (1, 0, 1) |
| V2 | (1, 0, −1) |
| V3 | (0, −2^{0.5}, 0) |
| V4 | (−1, 0, −1) |
| V5 | (−1, 0, 1) |

The faces can be represented on the basis of the vertexes. That is, each face can be represented by 3 vertexes. For example, the faces can be defined as shown in the following table.

TABLE 2

| Face id | Vertices |
|---|---|
| 0 | {V0, V1, V2} |
| 1 | {V3, V2, V1} |
| 2 | {V0, V4, V5} |
| 3 | {V3, V5, V4} |
| 4 | {V0, V5, V1} |
| 5 | {V3, V1, V5} |
| 6 | {V0, V2, V4} |
| 7 | {V3, V4, V2} |

Here, Face id represents a face corresponding to the value of Face id. For example, Face id can represent F0 when the value of Face id is 0, represent F1 when the value thereof is 1, represent F2 when the value thereof is 2, represent F3 when the value thereof is 3, represent F4 when the value thereof is 4, represent F5 when the value thereof is 5, represent F6 when the value thereof is 6 and represent F7 when the value thereof is 7. That is, Face id can represent Fn when the value thereof is n. Fn can be defined by 3 vertexes as shown in Table 2.

FIG. 12(b) shows a 3D projection structure with respect to the icosahedral projection scheme. The icosahedral 3D projection structure can be defined by 12 vertexes and 20 faces and regions representing the 20 faces can have regular triangular forms having the same size. The vertexes may be represented by V0 to V11 and the faces may be represented by F0 to F19. In addition, the positions of the vertexes represented in the XYZ coordinates may be defined as shown in the following table.

TABLE 3

| Vertex | F |
|---|---|
| V0 | (1, c, 0) |
| V1 | (−1, c, 0) |
| V2 | (1, −c, 0} |
| V3 | (−1, −c, 0) |
| V4 | (0, 1, c) |
| V5 | (0, −1, c) |
| V6 | (0, 1, −c) |
| V7 | (0, −1, −c) |
| V8 | (c, 0, 1} |
| V9 | (c, 0, −1) |
| V10 | (−c, 0, 1) |
| V11 | (−c, 0, −1) |

Here, c=(\sqrt{5}+1)/2, that is, c represents (\sqrt{5}+1)/2. Meanwhile, the faces can be represented by the vertexes. That is, each face can be represented by 3 vertexes. For example, the faces can be defined as shown in the following table.

TABLE 4

| Face id | f |
|---|---|
| 0 | {V0, V8, V9} |
| 1 | {V2, V9, V8} |
| 2 | {V0, V9, V6} |
| 3 | {V7, V6, V9} |
| 4 | {V0, V6, V1} |
| 5 | {V11, V1, V6} |
| 6 | {V0, V1, V4} |
| 7 | {V10, V4, V11} |
| 8 | {V0, V4, V8} |
| 9 | {V5, V8, V4} |
| 10 | {V3, V10, V11} |
| 11 | {V1, V11, V10} |
| 12 | {V3, V5, V10} |
| 13 | {V4, V10, V5} |
| 14 | {V3, V2, V5} |
| 15 | {V8, V5, V2} |
| 16 | {V3, V7, V2} |
| 17 | {V9, V2, V7} |
| 18 | {V3, V11, V7} |
| 19 | {V6, V7, V11} |

Here, Face id represents a face corresponding to the value of Face id. For example, Face id can represent F0 when the value of Face id is 0, represent F1 when the value thereof is 1, represent F2 when the value thereof is 2 and represent F3 when the value thereof is 3. That is, Face id can represent Fn when the value thereof is n. Fn can be defined by 3 vertexes as shown in Table 2.

Meanwhile, when the projection and region-wise packing process is performed on the 360 video data as described above, metadata with respect to the projection and region-wise packing process can be generated and signaled. For example, the metadata may be included and transmitted in a supplemental enhancement information (SEI) message or video usability information (VUI) of an AVC NAL unit or a HEVC NAL unit. The metadata and a metadata signaling method may be as follows. For example, when the video data is projected on the basis of the cubic projection scheme, a 360 video reception apparatus can appropriately map and render data of a region representing each face of a cube included in a frame to a 360 video space on the basis of the metadata.

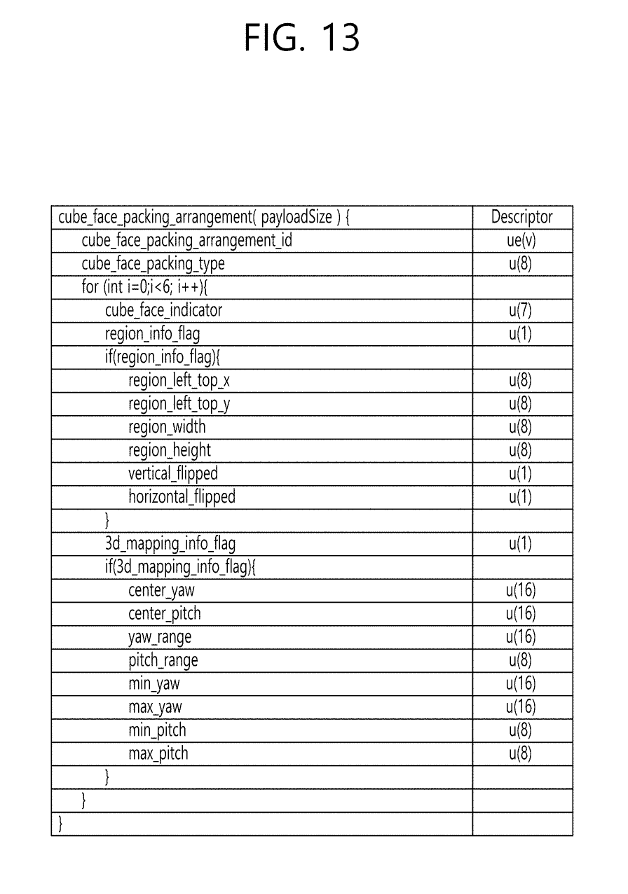

FIG. 13 shows an example of metadata with respect to the projection and region-wise packing process when 360 video data is projected on the basis of the cubic projection scheme. The metadata can represent how a region indicating each face of a cube to which the 360 video data in one frame is mapped has been packed. That is, the metadata representing how the region has been packed can be signaled.

Referring to FIG. 13, the metadata can include a cube_face_packing_arrangement_id field. The cube_face_packing_arrangement_id field can represent an identifier of a set of cube_face_packing related fields signaled after the cube_face_packing_arrangement_id field. In other words, the cube_face_packing_arrangement_id field can indicate a set of cube_face_packing related fields signaled after the cube_face_packing_arrangement_id field.

Referring to FIG. 13, the metadata can include a cube_face_packing_type field. The cube_face_packing_type field can indicate how faces of a cube are arranged on a frame. In other words, the cube_face_packing_type field can indicate a type in which regions representing the faces of the cube are arranged in the frame. Specifically, this field can indicate the numbers of columns and rows in which the regions representing the faces of the cube are arranged. Further, types may be as follows.

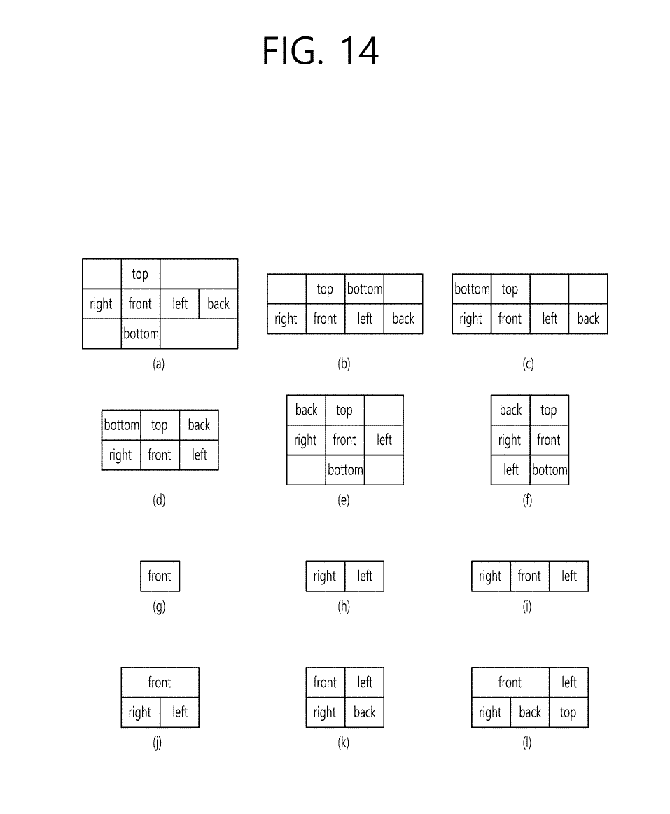

FIG. 14 illustrates types in which the faces of the cube are arranged in the frame. The faces of the cube can be arranged in a 4×3 cube map, that is, in 4 rows and 3 columns, as shown in FIG. 14(a).

Further, the faces of the cube can be arranged in a 4×2 cube map, that is, in 4 rows and 2 columns, as shown in FIG. 14(b) or 14(c).

Further, the faces of the cube can be arranged in a 3×2 cube map, that is, in 3 rows and 2 columns, as shown in FIG. 14(d).

Further, the faces of the cube can be arranged in a 3×3 cube map, that is, in 3 rows and 3 columns, as shown in FIG. 14(e).

Further, the faces of the cube can be arranged in a 2×3 cube map, that is, in 2 rows and 3 columns, as shown in FIG. 14(f).

Further, the faces of the cube can be arranged in a 1×1 cube map, that is, in one row and one column, as shown in FIG. 14(g). In this case, only one of the regions representing the faces of the cube can be arranged in the frame. The one region may be a front region or another region, as shown in FIG. 14(g).

Further, the faces of the cube can be arranged in a 2×1 cube map, that is, in 2 rows and one column, as shown in FIG. 14(h). In this case, only two of the regions representing the faces of the cube can be arranged in the frame. The two regions may include a right region and a left region or other regions, as shown in FIG. 14(h).

Further, the faces of the cube can be arranged in a 3×1 cube map, that is, in 3 rows and one column, as shown in FIG. 14(i). In this case, only three of the regions representing the faces of the cube can be arranged in the frame. The three regions may include a front region, a right region and a left region or other regions, as shown in FIG. 14(i).

Further, the faces of the cube can be arranged in a 2×2 cube map, that is, in 2 rows and 2 columns, as shown in FIG. 14(j) or 14(k). In this case, only three of the regions representing the faces of the cube can be arranged in the frame. The three regions may include a front region, a right region and a left region or other regions, as shown in FIG. 14(j). Alternatively, only four of the regions representing the faces of the cube can be arranged in the frame. The four regions may include a front region, a back region, a right region and a left region or other regions, as shown in FIG. 14(k).

Further, the faces of the cube can be arranged in a 2×3 cube map, that is, in 2 rows and 3 columns, as shown in FIG. 14(l). In this case, only five of the regions representing the faces of the cube can be arranged in the frame. The five regions may include a front region, a back region, a right region, a left region and a top region or other regions, as shown in FIG. 14(l).

Meanwhile, the cube_face_packing_type field can indicate how regions representing the faces of a cube are arranged in a frame. For example, the cube_face_packing_type field can indicate how regions representing the faces of a cube are arranged in a frame as shown in the following table.

TABLE 5

| Value | Interpretation |
|---|---|
| 0 | 4*3 cube map (arrangement in 4 columns and 3 rows can be |
| | indicated as shown in FIG. 14(a)) |
| 1 | 4*2 cube map (arrangement in 4 columns and 2 rows can be |
| | indicated as shown in FIG. 14(b) or (c)) |
| 2 | 3*2 cube map (arrangement in 3 columns and 2 rows can be |
| | indicated as shown in FIG. 14(d)) |
| 3 | 3*3 cube map (arrangement in 3 columns and 3 rows can be |
| | indicated as shown in FIG. 14(e)) |
| 4 | 2*3 cube map (arrangement in 2 columns and 3 rows can be |
| | indicated as shown in FIG. 14(f)) |
| 5 | Reserved |
| 6 | 1*1 cube map (one frame can include only one cube face |
| | as shown in FIG. 14(g)) |
| 7 | 2*1 cube map (one frame can include only 2 cube faces |
| | as shown in FIG. 14(h)) |
| 8 | 3*1 cube map (one frame can include only 3 cube faces |
| | as shown in FIG. 14(i)) |
| 9 | 2*2 cube map (one frame can include only 3 cube faces |
| | as shown in FIG. 14(j) or four cube faces as shown in FIG. 14(k)) |
| 10 | 2 rows and 3 columns (one frame can include 4 cube |
| | faces as shown in FIG. 14(l)) |
| 11-15 | Reserved |

When the value of the cube_face_packing_type field is 5 and 11 to 15, this field can be used in the future.

When the value of the cube_face_packing_type field is 0, the cube_face_packing_type field can indicate that the regions representing the faces of the cube are arranged in the frame in a 4×3 cube map, as shown in FIG. 14(a). That is, the cube_face_packing_type can indicate that the regions representing the faces of the cube are arranged in 4 rows and 3 columns.

Further, when the value of the cube_face_packing_type field is 1, the cube_face_packing_type field can indicate that the regions representing the faces of the cube are arranged in the frame in a 4×2 cube map, as shown in FIG. 14(b) or 14(c). That is, the cube_face_packing_type can indicate that the regions representing the faces of the cube are arranged in 4 rows and 2 columns.

Further, when the value of the cube_face_packing_type field is 2, the cube_face_packing_type field can indicate that the regions representing the faces of the cube are arranged in the frame in a 3×2 cube map, as shown in FIG. 14(d). That is, the cube_face_packing_type can indicate that the regions representing the faces of the cube are arranged in 3 rows and 2 columns.

Further, when the value of the cube_face_packing_type field is 3, the cube_face_packing_type field can indicate that the regions representing the faces of the cube are arranged in the frame in a 3×3 cube map, as shown in FIG. 14(e). That is, the cube_face_packing_type can indicate that the regions representing the faces of the cube are arranged in 3 rows and 3 columns.

Further, when the value of the cube_face_packing_type field is 4, the cube_face_packing_type field can indicate that the regions representing the faces of the cube are arranged in the frame in a 2×3 cube map, as shown in FIG. 14(f). That is, the cube_face_packing_type can indicate that the regions representing the faces of the cube are arranged in 2 rows and 3 columns.

Further, when the value of the cube_face_packing_type field is 6, the cube_face_packing_type field can indicate that the regions representing the faces of the cube are arranged in the frame in a 1×1 cube map, as shown in FIG. 14(g). That is, the cube_face_packing_type can indicate that the regions representing the faces of the cube are arranged in one row and one column. In this case, the frame can include one of the regions representing the faces of the cube.

Further, when the value of the cube_face_packing_type field is 7, the cube_face_packing_type field can indicate that the regions representing the faces of the cube are arranged in the frame in a 2×1 cube map, as shown in FIG. 14(h). That is, the cube_face_packing_type can indicate that the regions representing the faces of the cube are arranged in 2 rows and one column In this case, the frame can include two of the regions representing the faces of the cube.

Further, when the value of the cube_face_packing_type field is 8, the cube_face_packing_type field can indicate that the regions representing the faces of the cube are arranged in the frame in a 3×1 cube map, as shown in FIG. 14(i). That is, the cube_face_packing_type can indicate that the regions representing the faces of the cube are arranged in 3 rows and one column In this case, the frame can include three of the regions representing the faces of the cube.

Further, when the value of the cube_face_packing_type field is 9, the cube_face_packing_type field can indicate that the regions representing the faces of the cube are arranged in the frame in a 2×2 cube map, as shown in FIG. 14(j) or 14(k). That is, the cube_face_packing_type can indicate that the regions representing the faces of the cube are arranged in 2 rows and 2 columns. In this case, the frame can include three of the regions representing the faces of the cube. Alternatively, the frame can include four of the regions representing the faces of the cube.

Further, when the value of the cube_face_packing_type field is 10, the cube_face_packing_type field can indicate that the regions representing the faces of the cube are arranged in the frame in a 2×3 cube map, as shown in FIG. 14(l). That is, the cube_face_packing_type can indicate that the regions representing the faces of the cube are arranged in 2 rows and 3 columns. In this case, the frame can include five of the regions representing the faces of the cube.

Referring back to FIG. 13, the metadata can include a cube_face_indicator field. The cube_face_indicator field can indicate a mapping relationship between a specific region of a frame and a specific face of a cube. That is, the cube_face_indicator field can indicate a face of the face indicated by a specific region of the frame. For example, the cube_face_indicator field can indicate a face of the cube indicated by the specific region as shown in the following table.

TABLE 6

| Value | Interpretation |
|---|---|
| 0 | cube_front |
| 1 | cube_left |
| 2 | cube_back |
| 3 | cube_right |
| 4 | cube_top |
| 5 | cube_bottom |
| 6-7 | reserved |

When the value of the cube_face_indicator field is 6 and 7, this field can be used in the future.

When the value of the cube_face_indicator field is 0, the specific region of the frame can indicate the front of the cube. That is, the cube_face_indicator field can indicate that the specific region is the front region. Here, the cube_front can indicate the front region.

Further, when the value of the cube_face_indicator field is 1, the specific region of the frame can indicate the left of the cube. That is, the cube_face_indicator field can indicate that the specific region is the left region. Here, the cube_left can indicate the left region.

When the value of the cube_face_indicator field is 2, the specific region of the frame can indicate the back of the cube. That is, the cube_face_indicator field can indicate that the specific region is the back region. Here, the cube_back can indicate the back region.

When the value of the cube_face_indicator field is 3, the specific region of the frame can indicate the right of the cube. That is, the cube_face_indicator field can indicate that the specific region is the right region. Here, the cube_right can indicate the right region.

When the value of the cube_face_indicator field is 4, the specific region of the frame can indicate the top of the cube. That is, the cube_face_indicator field can indicate that the specific region is the top region. Here, the cube_top can indicate the top region.

When the value of the cube_face_indicator field is 5, the specific region of the frame can indicate the bottom of the cube. That is, the cube_face_indicator field can indicate that the specific region is the bottom region. Here, the cube_bottom can indicate the bottom region.

In addition, referring to FIG. 13, the metadata can include a region_info_flag field. The region_info_flag field can indicate whether the metadata includes information about a mapping area of the specific region indicating the specific face of the cube derived using the cube_face_indicator field. That is, the region_info_flag field can indicate whether the metadata includes information about a position in the frame at which the specific region is located. The information about the mapping area of the specific region can include information indicating coordinate values of the top-left pixel of the specific region, the width of the specific region and the height of the specific region. For example, the information about the mapping area can include a region_left_top_x field, a region_left_top_y field, a region_width field and a region_height field. The region_left_top_x field, the region_left_top_y field, the region_width field and the region_height field can be included in the metadata when the value of the region_info_flag field is 1. Since the same face of a cube may be mapped to regions having different sizes in a frame according to importance degree of face, information about a region mapped to each face, that is, the region_left_top_x field, the region_left_top_y field, the region_width field and the region_height field can be signaled, and thus a receiving side can derive a face of the cube which is mapped to the specific region in the frame more accurately and re-project data mapped to the specific region on spherical coordinates of a 3D space more accurately.

Specifically, the region_left_top_x field can indicate the x coordinate of the top-left pixel of a specific region mapped to a specific face of the cube in the frame, derived using the cube_face_indicator field. Further, the region_left_top_y field can indicate the y coordinate of the top-left pixel of the specific region mapped to the specific face of the cube in the frame, derived using the cube_face_indicator field. Further, the region_width field can indicate the width of the specific region mapped to the specific face of the cube in the frame, derived using the cube_face_indicator field. The width can be represented in unit of pixel. Further, the region_height field can indicate the height of the specific region mapped to the specific face of the cube in the frame, derived using the cube_face_indicator field. The height can be represented in unit of pixel.

In addition, referring to FIG. 13, the metadata can include a vertical_flipped field and a horizontal_flipped field. The vertical_flipped field can indicate whether a specific face of the cube indicated by the cube_face_indicator field has been flipped on the basis of the vertical axis and mapped to the specific region of the frame when the specific face is mapped to the specific region. Here, the vertical axis can represent an axis that is parallel to the vertical axis of the frame and passes through the center point of the specific region. Further, the horizontal_flipped field can indicate whether the specific face of the cube indicated by the cube_face_indicator field has been flipped on the basis of the horizontal axis and mapped to the specific region of the frame when the specific face is mapped to the specific region. Here, the horizontal axis can represent an axis that is parallel to the horizontal axis of the frame and passes through the center point of the specific region.

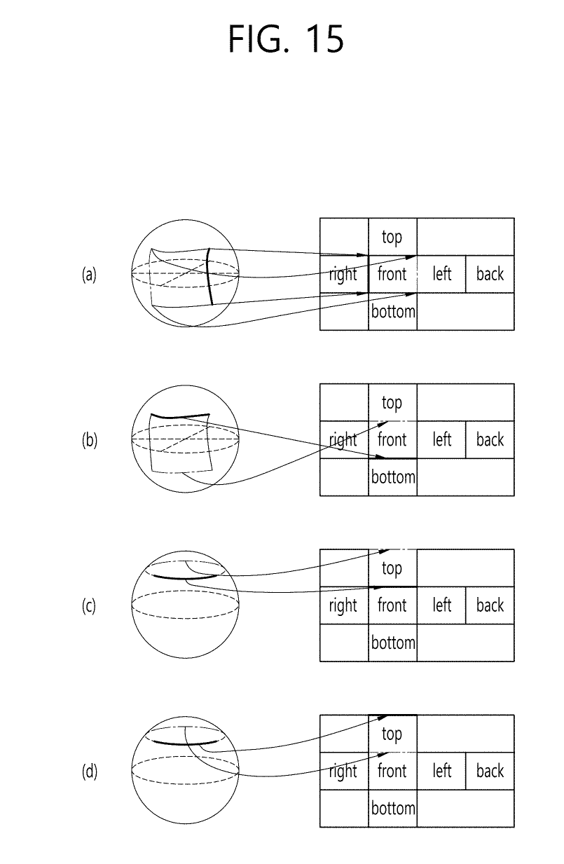

FIG. 15 illustrates flipped and mapped regions indicated by the vertical_flipped field and the horizontal_flipped field. FIG. 15(a) shows an example in which the front region of a cube is flipped on the basis of the horizontal axis and mapped when the value of the vertical_flipped field with respect to the front region is true, that is, the value of the vertical_flipped field is 1, for example. Specifically, when the value of the vertical_flipped field is true, the left line of the front region in the frame can be mapped to points having a minimum yaw value in the front face of the cube in the spherical coordinates of the 3D space and the right line of the front region can be mapped to points having a maximum yaw value in the front face of the cube in the spherical coordinates. Further, when the value of the vertical_flipped field is 0, for example, the front region of the cube can be mapped without being flipped on the basis of the vertical axis. Specifically, when the value of the vertical_flipped field is false, the left line of the front region in the frame can be mapped to points having a maximum yaw value in the front face of the cube in the spherical coordinates of the 3D space and the right line of the front region can be mapped to points having a minimum yaw value in the front face of the cube in the spherical coordinates.

In addition, FIG. 15(b) shows an example in which the front region of a cube is flipped on the basis of the horizontal axis and mapped when the value of the horizontal_flipped field with respect to the front region is true, that is, the value of the horizontal_flipped field is 1, for example. Specifically, when the value of the horizontal_flipped field is true, the top line of the front region in the frame can be mapped to points having a minimum pitch value in the front face of the cube in the spherical coordinates of the 3D space and the bottom line of the front region can be mapped to points having a maximum pitch value in the front face of the cube in the spherical coordinates. Further, when the value of the horizontal_flipped field is 0, for example, the front region of the cube can be mapped without being flipped on the basis of the horizontal axis. Specifically, when the value of the horizontal_flipped field is false, the top line of the front region in the frame can be mapped to points having a maximum pitch value in the front face of the cube in the spherical coordinates of the 3D space and the bottom line of the front region can be mapped to points having a minimum pitch value in the front face of the cube in the spherical coordinates.

The embodiment in which a region is flipped and mapped can be applied to regions other than the front region.

For example, when the value of the horizontal_flipped field with respect to the left, right or back region is 1, the left, right or back region of the cube can be flipped on the basis of the horizontal axis and mapped. Specifically, when the value of the horizontal_flipped field is true, the top line of the left, right or back region in the frame can be mapped to points having a minimum pitch value in the left, right or back face of the cube in the spherical coordinates of the 3D space and the bottom line of the left, right or back region can be mapped to points having a maximum pitch value in the left, right or back face of the cube in the spherical coordinates. Further, when the value of the horizontal_flipped field is 0, for example, the left, right or back region of the cube can be mapped without being flipped on the basis of the horizontal axis. Specifically, when the value of the horizontal_flipped field is false, the top line of the left, right or back region in the frame can be mapped to points having a maximum pitch value in the left, right or back face of the cube in the spherical coordinates of the 3D space and the bottom line of the left, right or back region can be mapped to points having a minimum pitch value in the left, right or back face of the cube in the spherical coordinates.

In addition, FIGS. 15(c) and (d) show an embodiment in which the top region indicated by the horizontal_flipped field is flipped and an embodiment in which the top region is mapped without being flipped. For example, in FIG. 15(c), when the value of the horizontal_flipped field is 0, the top region of the cube can be mapped without being flipped on the basis of the horizontal axis. Specifically, when the value of the horizontal_flipped field is false, the top line of the top region in the frame can be mapped to points having a minimum pitch value of the top face of the cube and yaw values in the range of 90 to 270 degrees in the spherical coordinates of the 3D space and the bottom line of the top region can be mapped to points having a minimum pitch value of the top face of the cube and yaw values in the range of 270 to 360 degrees and 0 to 90 degrees in the spherical coordinates. In addition, FIG. 15(d) show an example in which the top region of the cube is flipped on the horizontal axis when the value of the horizontal_flipped field with respect to the top region is 1. Specifically, when the value of the horizontal_flipped field is true, the top line of the top region in the frame can be mapped to points having a minimum pitch value of the top face of the cube and yaw values in the range of 270 to 360 and 0 to 90 degrees in the spherical coordinates of the 3D space and the bottom line of the top region can be mapped to points having a minimum pitch value of the top face of the cube and yaw values in the range of 90 to 270 degrees in the spherical coordinates.

When each face of a cube is flipped on the basis of the horizontal/vertical axis and mapped, as described above, information thereon can be signaled through the vertical_flipped field and/or the horizontal_flipped field and a reception side (e.g., a 360 video reception apparatus) can re-project data regarding a specific region in the frame on the spherical coordinates of the 3D space more accurately using the information.

In addition, referring to FIG. 13, the metadata can include a 3d_mapping_info_flag field. The 3d_mapping_info_flag field may be a flag indicating presence or absence of information about a region on the spherical coordinates of the 3D space which is mapped to a region representing each face of a cube. When the value of the 3d_mapping_info_flag field indicating a specific region representing a specific face of the cube is true, that is, when the value of the 3d_mapping_info_flag field is 1, the metadata can include a center_yaw field, a center_pitch field, a yaw range field, a pitch_range field, a min_yaw field, a max_yaw field, a min_pitch field and/or a max_pitch field.

The center_yaw field can indicate a yaw angle value of a point on the spherical coordinates in the frame, which is mapped to the center pixel of the region representing the specific face of the cube. Further, the center_pitch field can indicate a pitch angle value of the point on the spherical coordinates in the frame, which is mapped to the center pixel of the region representing the specific face of the cube. Further, the min_yaw field can indicate a minimum yaw angle value of the region on the spherical coordinates mapped to the region representing the specific face in the frame. Further, the max_yaw field can indicate a maximum yaw angle value of the region on the spherical coordinates mapped to the region representing the specific face in the frame. Further, the min_pitch field can indicate a minimum pitch angle value of the region on the spherical coordinates mapped to the region representing the specific face in the frame. Further, the max_pitch field can indicate a maximum pitch angle value of the region on the spherical coordinates mapped to the region representing the specific face in the frame. Further, the yaw_range field can indicate a yaw angle range of the region on the spherical coordinates mapped to the region representing the specific face in the frame. A specific value of the yaw angle range can be derived through the center_yaw field and the yaw_range field, and the yaw angle range of the region on the spherical coordinates may be center_yaw−yaw_range/2 to center_yaw+yaw_range/2. Further, the pitch_range field can indicate a pitch angle range of the region on the spherical coordinates mapped to the region representing the specific face in the frame. A specific value of the pitch angle range can be derived through the center_pitch field and the pitch_range field, and the pitch angle range of the region on the spherical coordinates may be center_pitch−pitch_range/2 to center_pitch+pitch_range/2.

Region in the 3D space mapped to regions in the frame can be represented as follows on the basis of the aforementioned fields.

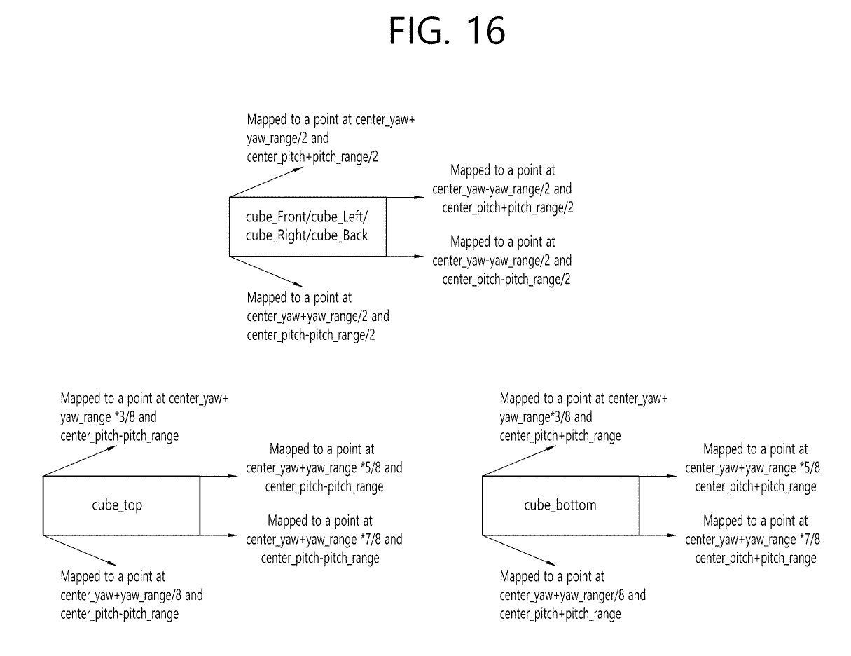

FIG. 16 illustrates regions in the 3D space mapped to regions in a frame. Referring to FIG. 16(a), a region on the spherical coordinates of the 3D space to which the front region, the left region, the right region or the back region is mapped can be derived on the basis of the aforementioned fields. Specifically, a point at a yaw angle of center_yaw+yaw_range/2 and a pitch angle of center_pitch+pitch_range/2 in the spherical coordinates can be mapped to the top-left pixel of the front region, the left region, the right region or the back region and a point at a yaw angle of center_yaw−yaw_range/2 and a pitch angle of center_pitch+pitch_range/2 in the spherical coordinates can be mapped to the top-right pixel of the front region, the left region, the right region or the back region. Further, a point at a yaw angle of center_yaw+yaw_range/2 and a pitch angle of center_pitch−pitch_range/2 in the spherical coordinates can be mapped to the bottom-left pixel of the front region, the left region, the right region or the back region and a point at a yaw angle of center_yaw−yaw_range/2 and a pitch angle of center_pitch−pitch_range/2 in the spherical coordinates can be mapped to the bottom-right pixel of the front region, the left region, the right region or the back region.

In addition, referring to FIG. 16(b), a region on the spherical coordinates of the 3D space to which the top region is mapped can be derived on the basis of the aforementioned fields. Specifically, a point at a yaw angle of center_yaw+yaw_range*⅜ and a pitch angle of center_pitch−pitch_range in the spherical coordinates can be mapped to the top-left pixel of the top region and a point at a yaw angle of center_yaw+yaw_range*⅝ a pitch angle of center_pitch−pitch_range in the spherical coordinates can be mapped to the top-right pixel of the top region. Further, a point at a yaw angle of center_yaw+yaw_range/8 and a pitch angle of center_pitch−pitch_range in the spherical coordinates can be mapped to the bottom-left pixel of the top region and a point at a yaw angle of center_yaw+yaw_range*⅞ and a pitch angle of center_pitch−pitch_range in the spherical coordinates can be mapped to the bottom-right pixel of the top region.

In addition, referring to FIG. 16(c), a region on the spherical coordinates of the 3D space to which the bottom region is mapped can be derived on the basis of the aforementioned fields. Specifically, a point at a yaw angle of center_yaw+yaw_range*⅜ and a pitch angle of center_pitch+pitch_range in the spherical coordinates can be mapped to the top-left pixel of the bottom region and a point at a yaw angle of center_yaw+yaw_range*⅝ a pitch angle of center_pitch+pitch_range in the spherical coordinates can be mapped to the top-right pixel of the bottom region. Further, a point at a yaw angle of center_yaw+yaw_range/8 and a pitch angle of center_pitch+pitch_range in the spherical coordinates can be mapped to the bottom-left pixel of the bottom region and a point at a yaw angle of center_yaw+yaw_range*⅞ and a pitch angle of center_pitch+pitch_range in the spherical coordinates can be mapped to the bottom-right pixel of the bottom region.

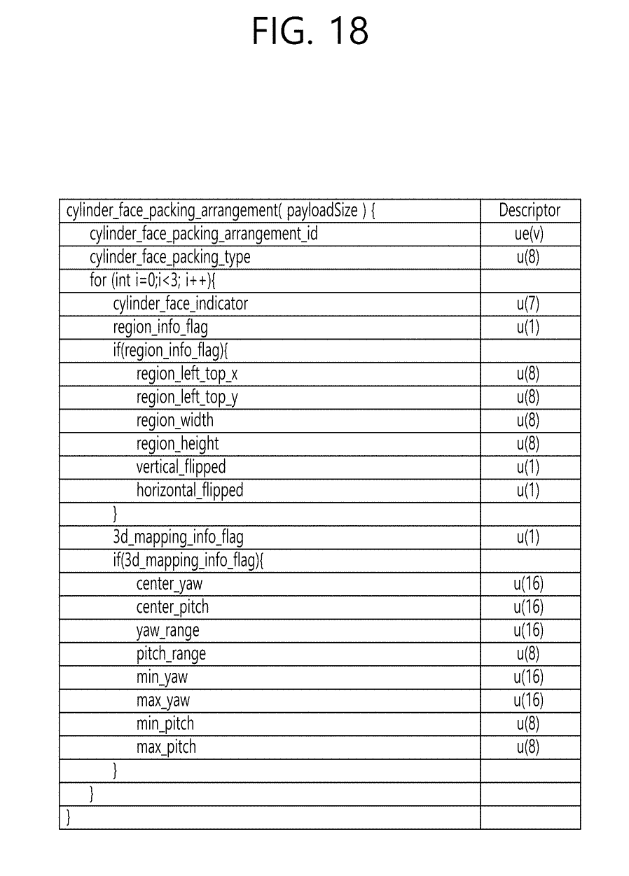

Meanwhile, although 360 video data can be included in one frame and signaled, the 360 video data may be included in a plurality of frames and signaled. In this case, metadata with respect to projection and region-wise packing can be signaled as shown in FIG. 18.

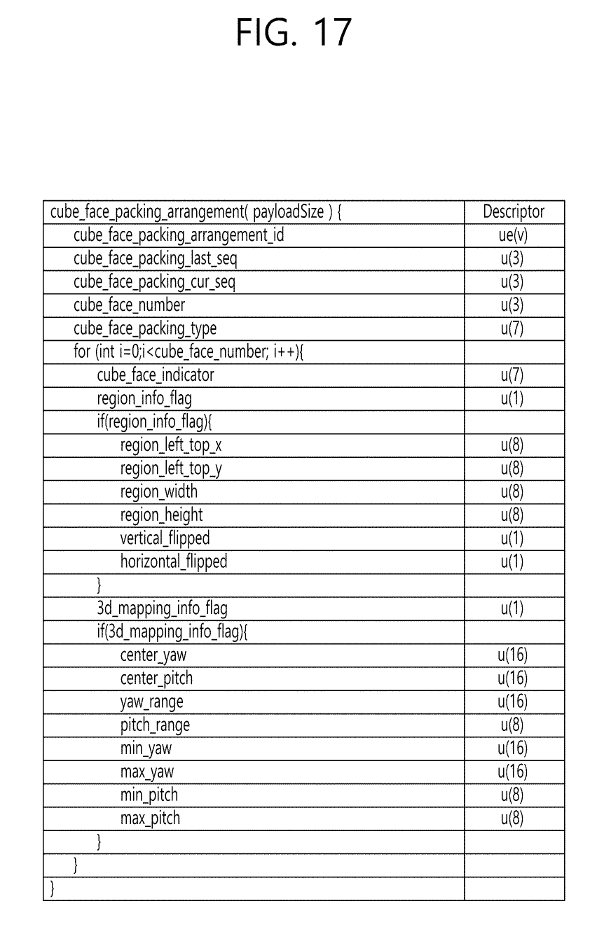

FIG. 17 shows an example of metadata with respect to a projection and region-wise packing process when 360 video data is projected on the basis of the cubic projection scheme. Referring to FIG. 17, the metadata can include the aforementioned cube_face_packing_arrangement_id field, cube_face_packing_type field, cube_face_indicator field, region_info_flag field, region_left_top_x field, region_left_top_y field, region_width field, region_height field, vertical_flipped field, horizontal_flipped field, 3d_mapping_info_flag field, center_yaw field, center_pitch field, yaw_range field, pitch_range field, min_yaw field, max_yaw field, min_pitch field and/or max_pitch field. The meanings of the these fields have been described.

In addition, the metadata can include a cube_face_packing_last_seq field. The cube_face_packing_last_seq field can indicate the sequence number of a finally transmitted frame among frames including 360 video data when the 360 video data is included and transmitted in one or more frames. In addition, the metadata can include a cube_face_packing_cur_seq field. The cube_face_packing_cur_seq field can indicate the sequence number of the current frame when the 360 video data is included and transmitted in one or more frames. For example, when the current frame is a frame transmitted first among the frames including the 360 video data, the sequence number indicated by the cube_face_packing_cur_seq field can be 1. Further, the metadata can include a cube_face_number field. The cube_face_number field can indicate the number of regions representing cube faces included in a current frame. For example, the number of regions representing cube faces included in the current frame can be as shown in the following table.

TABLE 7

| Value | Interpretation |
|---|---|
| 0 | This can represent that the number of cube faces included |
| | in an image frame or which cube face is included is not defined. |
| 1 | This can represent that only one cube face is included in an |
| | image frame. |
| 2 | This can represent that 2 cube faces are included in an |
| | image frame. |
| 3 | This can represent that 3 cube faces are included in an |
| | image frame. |
| 4 | This can represent that 4 cube faces are included in an |
| | image frame. |
| 5 | This can represent that 5 cube faces are included in an |
| | image frame. |
| 6 | This can represent that all of 6 cube faces are included in an |
| | image frame. |
| 7 | Reserved |

When the value of the cube_face_number field is 7, it can be used in the future.

When the value of the cube_face_number field is 0, the cube_face_number field can represent that the number of regions representing cube faces included in the current frame or which region is included in the frame is not defined.

Further, when the value of the cube_face_number field is 1, the cube_face_number field can represent that the number of regions representing cube faces included in the current frame is 1. That is, this field can indicate that the number of regions is 1. That is, the cube_face_number field can indicate that the current frame includes a region representing one cube face. For example, when the current frame includes only the front region of the cube, the cube_face_number field is allocated to 1 and signaled and the cube_face_indicator field can be allocated to a value indicating the cube_front and signaled.

Further, when the value of the cube_face_number field is 2, the cube_face_number field can represent that the number of regions representing cube faces included in the current frame is 2. That is, the cube_face_number field can indicate that the current frame includes 2 regions representing cube faces. That is, the cube_face_number field can indicate that the current frame includes 2 regions.

Further, when the value of the cube_face_number field is 3, the cube_face_number field can represent that the number of regions representing cube faces included in the current frame is 3. That is, the cube_face_number field can indicate that the current frame includes 3 regions.

Further, when the value of the cube_face_number field is 4, the cube_face_number field can represent that the number of regions representing cube faces included in the current frame is 4. That is, the cube_face_number field can indicate that the current frame includes 4 regions.

Further, when the value of the cube_face_number field is 5, the cube_face_number field can represent that the number of regions representing cube faces included in the current frame is 5. That is, the cube_face_number field can indicate that the current frame includes 5 regions.

Further, when the value of the cube_face_number field is 6, the cube_face_number field can represent that the number of regions representing cube faces included in the current frame is 6. That is, the cube_face_number field can indicate that the current frame includes 6 regions.

Meanwhile, when 360 video data projected on the basis of the cubic projection scheme is transmitted through a plurality of frames, a client/360 video reception apparatus can identify the start, continuation and end of a frame including the 360 video data through a sequence number derived on the basis of the aforementioned fields and thus can determine whether reception of the 360 video data is completed.

Although 360 video data can be projected on the basis of the cubic projection scheme, the 360 video data may be projected on the basis of a cylindrical projection scheme. In this case, metadata with respect to the projection and region-wise packing process can be generated and signaled. For example, a 360 video reception apparatus can appropriately map and render data of a region representing each face of a cylinder included in a frame to a 360 video space on the basis of the metadata.

FIG. 18 shows an example of metadata with respect to projection and region-wise packing when 360 video data is projected on the basis of the cylindrical projection scheme.

The metadata can indicate how a region representing each face of a cylinder to which 360 video data in a frame is mapped has been packed. That is, metadata indicating how the region has been packed can be signaled.

Referring to FIG. 18, the metadata can include a cylinder_face_packing_arrangement_id field. The cylinder_face_packing_arrangement_id field can represent the identifier of a set of cylinder_face_packing related fields signaled after the cylinder_face_packing_arrangement_id field. In other words, the cylinder_face_packing_arrangement_id field can indicate a set including cylinder_face_packing related fields signaled after the cylinder_face_packing_arrangement_id field.

Referring to FIG. 18, the metadata can include a cylinder_face_packing_type field. The cylinder_face_packing_type field can indicate how regions representing faces of a cylinder are arranged in a frame. In other words, the cylinder_face_packing_type field can indicate types in which regions representing faces of the cylinder are arranged in the frame. Specifically, the field can indicate the numbers of columns and rows in which the regions representing the faces of the cylinder are arranged. Further, the types can be represented as follows.

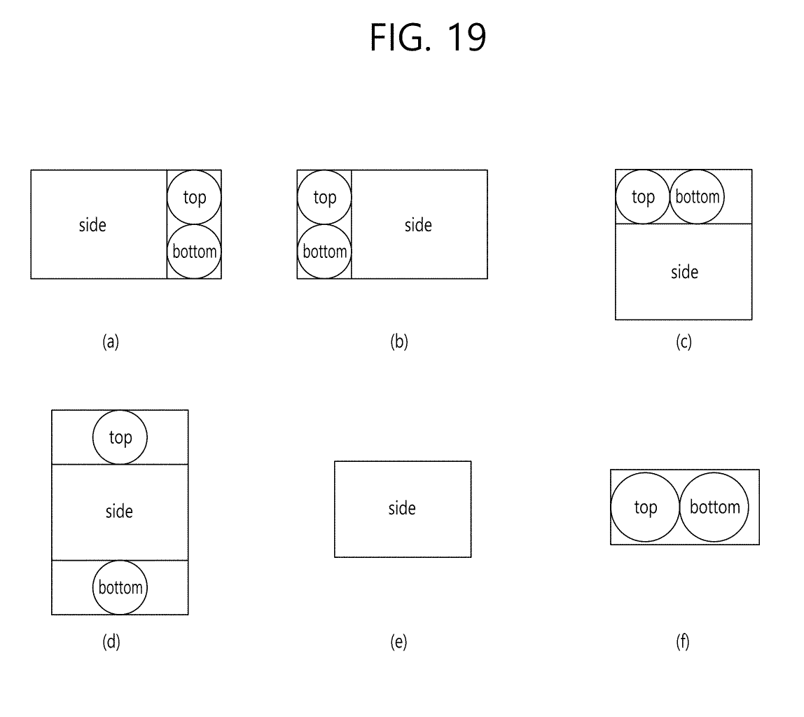

FIG. 19 illustrates types in which the faces of the cylinder are arranged in the frame. The faces of the cylinder may be arranged in such a manner that the side region of the cylinder is arranged on the left of the frame, the top region is arranged at the upper side of the right of the frame and the bottom region is arranged at the lower side of the right of the frame, as shown in FIG. 19(a).

Further, the faces of the cylinder may be arranged in such a manner that the side region of the cylinder is arranged on the right of the frame, the top region is arranged at the upper side of the left of the frame and the bottom region is arranged at the lower side of the left of the frame, as shown in FIG. 19(b).

Further, the faces of the cylinder may be arranged in such a manner that the side region of the cylinder is arranged at the lower side of the frame, the top region is arranged at the upper side of the right of the frame and the bottom region is arranged at the upper side of the left of the frame, as shown in FIG. 19(c).

Further, the faces of the cylinder may be arranged in such a manner that the side region of the cylinder is arranged in the middle of the frame, the top region is arranged at the upper side of the frame and the bottom region is arranged at the lower side of the frame, as shown in FIG. 19(d).

Further, the faces of the cylinder may be arranged in such a manner that only the side region of the cylinder is arranged at the lower side of the frame, as shown in FIG. 19(e).

Further, the faces of the cylinder may be arranged in such a manner that the top region of the cylinder is arranged on the right of the frame and the bottom region is arranged on the left of the frame, as shown in FIG. 19(f). In this case, the frame may not include the side region.

As described above, the cylinder_face_packing_type field can represent how regions representing the faces of the cylinder are arranged in the frame. For example, the cylinder_face_packing_type field can represent how the regions representing the faces of the cylinder are arranged in the frame as shown in the following tables.

TABLE 8

| Value | Interpretation |
|---|---|
| 0 | This can represent that cylinder faces are arranged in one frame, |
| | as shown in FIG. 19(a). |
| 1 | This can represent that cylinder faces are arranged in one frame, |
| | as shown in FIG. 19(b). |
| 2 | This can represent that cylinder faces are arranged in one frame, |
| | as shown in FIG. 19(c). |
| 3 | This can represent that cylinder faces are arranged in one frame, |
| | as shown in FIG. 19(d). |
| 4 | This can represent that cylinder faces are arranged in one frame, |
| | as shown in FIG. 19(e). |
| 5 | This can represent that cylinder faces are arranged in one frame, |
| | as shown in FIG. 19(f). |
| 6-15 | Reserved |

When value of the cylinder_face_packing_type is 6 to 16, this can be used in the future.

When the value of the cylinder_face_packing_type field is 0, the cylinder_face_packing_type field can indicate that the regions representing the cylinder faces are arranged in the frame, as shown in FIG. 19(a). Further, when the value of the cylinder_face_packing_type field is 1, the cylinder_face_packing_type field can indicate that the regions representing the cylinder faces are arranged in the frame, as shown in FIG. 19(b). Further, when the value of the cylinder_face_packing_type field is 2, the cylinder_face_packing_type field can indicate that the regions representing the cylinder faces are arranged in the frame, as shown in FIG. 19(c). Further, when the value of the cylinder_face_packing_type field is 3, the cylinder_face_packing_type field can indicate that the regions representing the cylinder faces are arranged in the frame, as shown in FIG. 19(d). Further, when the value of the cylinder_face_packing_type field is 4, the cylinder_face_packing_type field can indicate that the regions representing the cylinder faces are arranged in the frame, as shown in FIG. 19(e). Further, when the value of the cylinder_face_packing_type field is 5, the cylinder_face_packing_type field can indicate that the regions representing the cylinder faces are arranged in the frame, as shown in FIG. 19(f).

Referring back to FIG. 18, the metadata can include a cylinder_face_indicator field. The cylinder_face_indicator field can represent a mapping relationship between a specific region of a frame and a specific face of a cylinder. That is, the cylinder_face_indicator field can indicate a cylinder face represented by a specific region of the frame. For example, the cylinder_face_indicator field can indicate a cylinder face indicated by a specific region, as shown in the following table.

TABLE 9

| Value | Interpretation |
|---|---|
| 0 | cylinder_side |
| 1 | cylinder_top |
| 2 | cylinder_botom |
| 3-7 | reserved |

When the value of the cylinder_face_indicator field is 3 to 7, this can be used in the future.

When the value of the cylinder_face_indicator field is 0, the specific region of the frame can indicate the side of the cylinder. That is, the cylinder_face_indicator field can indicate that the specific region is the side region. Here, the cylinder_side can represent the side region.

Further, when the value of the cylinder_face_indicator field is 1, the specific region of the cylinder can indicate the top of the cylinder. That is, the cylinder_face_indicator field can indicate that the specific region is the top region. Here, the cylinder_top can represent the top region.

When the value of the cylinder_face_indicator field is 2, the specific region of the cylinder can indicate the bottom of the cylinder. That is, the cylinder_face_indicator field can indicate that the specific region is the bottom region. Here, the cylinder_bottom can represent the bottom region.

Referring to FIG. 18, the metadata can include a region_info_flag field. The region_info_flag field can indicate whether information about a mapping area of a specific region representing a specific face of the cylinder, derived using the cylinder_face_indicator field, is included in the metadata. That is, the region_info_flag field can indicate whether information about a position of the specific region in the frame is included in the metadata. The information about the mapping area of the specific region can include coordinate values of the top-left pixel of the specific region and information representing the width and the height of the specific region. For example, the information about the mapping area can include a region_left_top_x field, a region_left_top_y field, a region_width field and a region_height field. The region_left_top_x field, the region_left_top_y field, the region_width field and the region_height field can be included in the metadata when the value of the region_info_flag field is 1. Since even the same cylinder face may be mapped to regions having different sizes in a frame according to importance of the face, information about a region mapped to each cylinder face, that is, the region_left_top_x field, the region_left_top_y field, the region_width field and the region_height field can be signaled. Accordingly, a reception side can derive a cylinder face mapped to the specific region more accurately and re-project data mapped to the specific region on spherical coordinates of the 3D space more accurately.

Specifically, the region_left_top_x field can indicate an x coordinate of the top-left pixel of a specific region mapped to a specific face of the cylinder in the frame, which is derived using the cylinder_face_indicator field. Further, the region_left_top_y field can indicate a y coordinate of the top-left pixel of the specific region mapped to the specific face of the cylinder in the frame, which is derived using the cylinder_face_indicator field. Further, the region_width field can indicate the width of the specific region mapped to the specific face of the cylinder in the frame, which is derived using the cylinder_face_indicator field. The width can be indicated in unit of pixel. Further, the region_height field can indicate the height of the specific region mapped to the specific face of the cylinder in the frame, which is derived using the cylinder_face_indicator field. The height can be indicated in unit of pixel.

In addition, referring to FIG. 18, the metadata can include a vertical_flipped field and a horizontal_flipped field. The vertical_flipped field can indicate whether a specific face of the cylinder indicated by the cylinder_face_indicator field has been flipped on the basis of the vertical axis and mapped when the specific face is mapped to the specific region. Here, the vertical axis can represent an axis that is parallel to the vertical axis of the frame and passes through the center point of the specific region. Further, the horizontal_flipped field can indicate whether the specific face of the cylinder indicated by the cylinder_face_indicator field has been flipped on the basis of the horizontal axis and mapped when the specific face is mapped to the specific region. Here, the horizontal axis can represent an axis that is parallel to the horizontal axis of the frame and passes through the center point of the specific region.

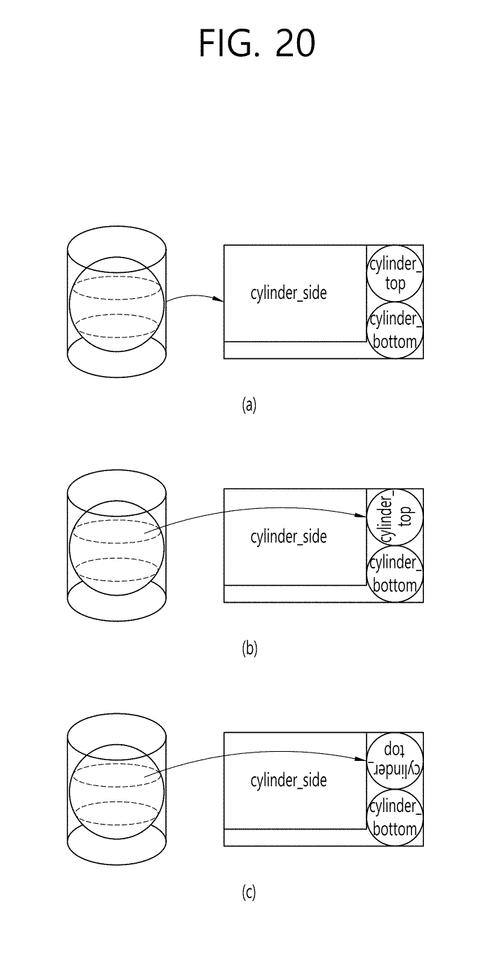

FIG. 20 illustrates flipped and mapped regions indicated by the vertical_flipped field and the horizontal_flipped field. FIG. 20(a) shows a case in which the values of the vertical_flipped field and the horizontal_flipped field with respect to the top region are false, that is, a case in which the values of the vertical_flipped field and the horizontal_flipped field are 0.

FIG. 20(b) shows an example in which the top region of the cylinder is flipped on the basis of the vertical axis and mapped when the value of the vertical_flipped field with respect to the top region is true, that is, when the value of the vertical_flipped field is 1. Specifically, when the value of the vertical_flipped field is true, the top region can be mapped on the frame in the same manner as the top region mapped without being flipped on the basis of the vertical axis and the horizontal axis rotates by 90 degrees counterclockwise.

In addition, FIG. 20(c) shows that the top region can be mapped on the frame in the same manner as the top region mapped without being flipped on the basis of the vertical axis and the horizontal axis rotates by 180 degrees counterclockwise (clockwise) when the value of the horizontal_flipped field with respect to the top region is true, that is, when the value of the horizontal_flipped field is 1.

The embodiment in which a region is flipped and mapped can be applied to the bottom region and the side region as well as the top region.

When each face of the cylinder is flipped on the basis of the horizontal axis/vertical axis and mapped as described above, information thereabout can be signaled through the vertical_flipped field and/or the horizontal_flipped field and a reception side (360 video reception apparatus) can re-project data regarding a specific region in the frame on spherical coordinates of the 3D space more accurately using the information.

Referring back to FIG. 18, the metadata can include a 3d_mapping_info_flag field. The 3d_mapping_info_flag field is a flag indicating presence or absence of information about a region on the spherical coordinates of the 3D space which is matched to a region representing each face of the cylinder. When the value of the 3d_mapping_info_flag field with respect to a specific region representing a specific face of the cylinder is true, that is, when the value of the 3d_mapping_info_flag field is 1, the metadata can include a center_yaw field, a center_pitch field, a yaw_range field, a pitch_range field, a min_yaw field, a max_yaw field, a min_pitch field and/or a max_pitch field with respect to the specific region.

The center_yaw field can represent a yaw angle value of a point on the spherical coordinates mapped to the center pixel of a region representing the specific face of the cylinder in the frame. Further, the center_pitch field can represent a pitch angle value of the point on the spherical coordinates mapped to the center pixel of the region representing the specific face of the cylinder in the frame. Further, the min_yaw field can represent a minimum yaw angle value of a region on the spherical coordinates mapped to the region representing the specific face in the frame. Further, the max_yaw field can represent a maximum yaw angle value of the region on the spherical coordinates mapped to the region representing the specific face in the frame. Further, the min_pitch field can represent a minimum pitch angle value of the region on the spherical coordinates mapped to the region representing the specific face in the frame. Further, the max_pitch field can represent a maximum pitch angle value of the region on the spherical coordinates mapped to the region representing the specific face in the frame. Further, the yaw_range field can represent a yaw angle range of the region on the spherical coordinates mapped to the region representing the specific face in the frame. A specific value of the yaw angle range can be derived using the center_yaw field and the yaw_range field. The yaw angle range of the region on the spherical coordinates can be center_yaw−yaw_range/2 to center_yaw+yaw_range/2. Further, the pitch_range field can represent a pitch angle range of the region on the spherical coordinates mapped to the region representing the specific face in the frame. A specific value of the pitch angle range can be derived using the center_pitch field and the pitch_range field. The pitch angle range of the region on the spherical coordinates can be center_pitch−pitch_range/2 to center_pitch+pitch_range/2.

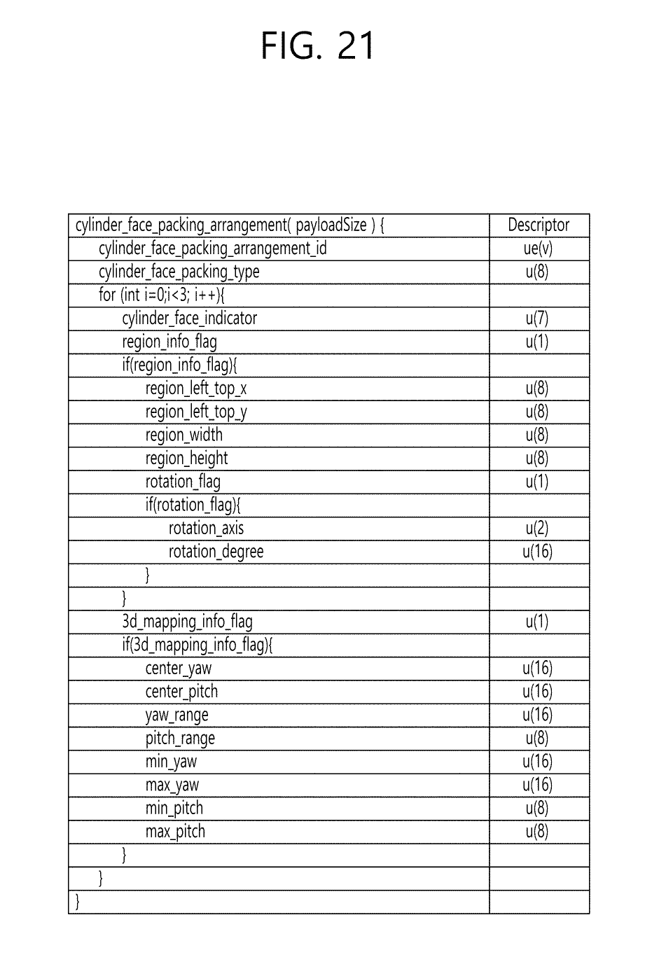

Meanwhile, although how a region has been mapped on the frame can be represented on the basis of the vertical_flipped field and/or the horizontal_flipped field when 360 video data is projected on the basis of the cylindrical projection scheme, how a region has been mapped on the frame may be represented using information representing whether the region is rotated and mapped. In this case, metadata with respect to projection and region-wise packing may be signaled as shown in FIG. 21.

FIG. 21 shows an example of metadata with respect to projection and region-wise packing when 360 video data is projected on the basis of the cylindrical projection scheme. Referring to FIG. 21, the metadata can include the aforementioned cylinder_face_packing_arrangement_id field, cylinder_face_packing_type field, cylinder_face_indicator field, region_info_flag field, region_left_top_x field, region_left_top_y field, region_width field, region_height field, 3d_mapping_info_flag field, center_yaw field, center_pitch field, yaw_range field, pitch_range field, min_yaw field, max_yaw field, min_pitch field and/or max_pitch field. The meanings of these fields have been described above.

In addition, the metadata can include a rotation_flag field. The rotation_flag field is a flag indicating whether rotation is applied to a specific region representing a specific face of the cylinder when the specific region is projected on the frame. The rotation can be included in the region-wise packing process. When the value of the rotation_flag field is true, that is, when the value of the rotation_flag field is 1, the field can indicate that rotation is applied to the specific region when the specific region is projected.

When the value of the rotation_flag field is 1, the metadata can include a rotation_axis field and/or a rotation_degree field. The region_rotation_axis field can represent a reference axis that is a reference of rotation when the specific region is rotated and projected. The reference axis can include the upward direction of the vertical axis of the frame, the downward direction of the vertical axis, the left direction of the horizontal axis or the right direction of the horizontal axis. That is, the region_rotation_axis field can indicate a reference axis that is a reference of rotation applied to the specific region among the upward direction of the vertical axis of the frame, the downward direction of the vertical axis, the left direction of the horizontal axis and the right direction of the horizontal axis. Further, the rotation_degree field can indicate an angle rotated clockwise on the basis of the reference axis. Here, the value of the angle may increase clockwise or may be in a range of 0 to 360 degrees.

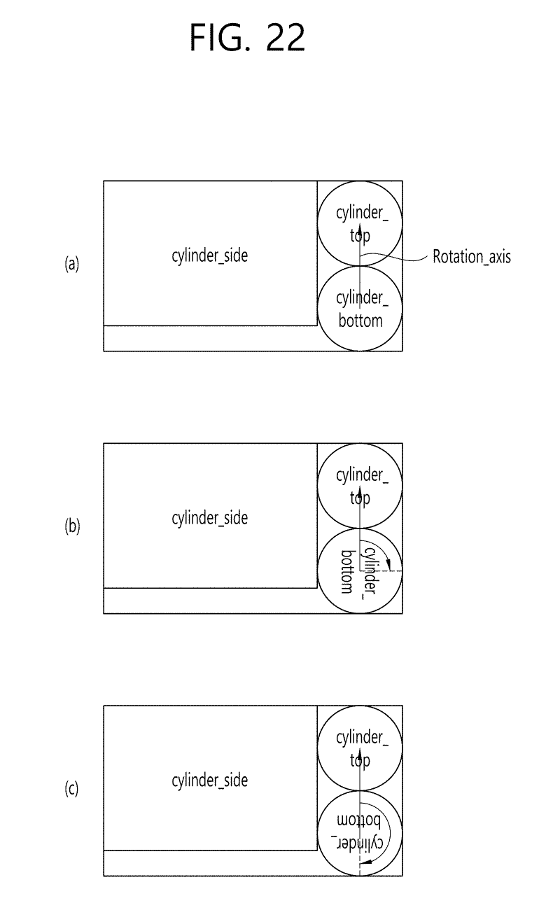

FIG. 22 illustrates a bottom region rotated on the basis of the rotation_axis field and the rotation_degree field and projected. FIG. 22(a) shows a bottom region rotated by 0 degrees clockwise having the upward direction of the vertical axis as a reference axis. In this case, the rotation_axis field with respect to the bottom region can indicate the upward direction of the vertical axis as a reference axis. Further, the rotation_degree field with respect to the bottom region can indicate 0 degrees.

FIG. 22(b) shows a bottom region rotated by 90 degrees clockwise having the upward direction of the vertical axis as a reference axis. In this case, the rotation_axis field with respect to the bottom region can indicate the upward direction of the vertical axis as a reference axis. Further, the rotation_degree field with respect to the bottom region can indicate 90 degrees.

FIG. 22(c) shows a bottom region rotated by 180 degrees counterclockwise having the upward direction of the vertical axis as a reference axis. In this case, the rotation_axis field with respect to the bottom region can indicate the upward direction of the vertical axis as a reference axis. Further, the rotation_degree field with respect to the bottom region can indicate 180 degrees.

Meanwhile, the top region or the side region of the cylinder may also be rotated and projected although not illustrated, and information about the rotation can be signaled through the rotation_axis field and the rotation_degree field with respect to the top region or the side region.

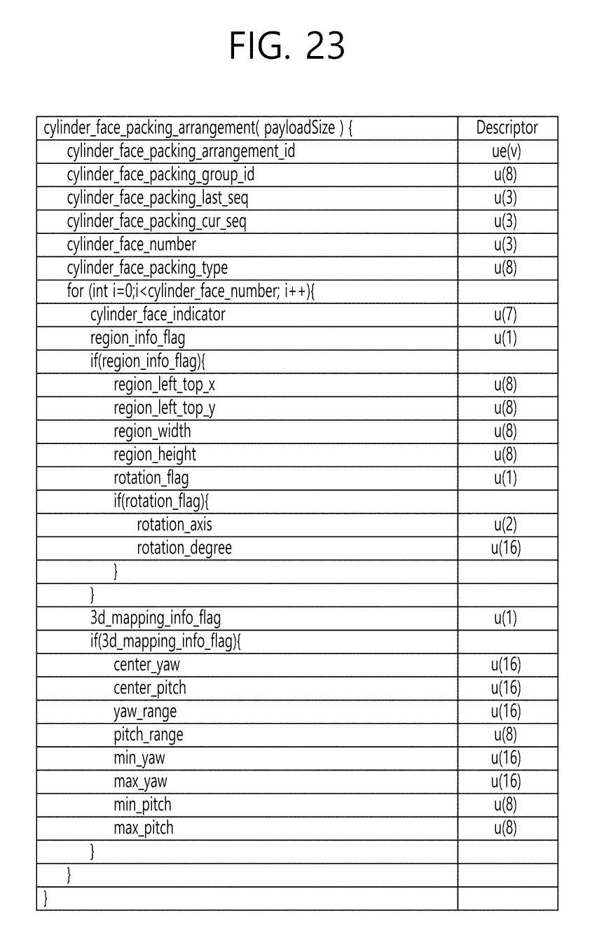

Although 360 video data can be included in one frame and signaled, the 360 video data may be included in a plurality of frames and signaled. In this case, metadata related to projection and region-wise packing can be signaled as shown in FIG. 23.

FIG. 23 shows an example of metadata related to projection and region-wise packing when 360 video data is projected on the basis of the cylindrical projection scheme. Referring to FIG. 23, the metadata can include the aforementioned cylinder_face_packing_arrangement_id field, cylinder_face_packing_type field, cylinder_face_indicator field, region_info_flag field, region_left_top_x field, region_left_top_y field, region_width field, region_height field, rotation_flag field, rotation_axis field, rotation_degree field, 3d_mapping_info_flag field, center_yaw field, center_pitch field, yaw_range field, pitch_range field, min_yaw field, max_yaw field, min_pitch field and/or max_pitch field. The meanings of these fields have been described above.

In addition, the metadata can include a cylinder_face_packing_group_id field. When the 360 video data is included and transmitted in one or more consecutive frames, the cylinder_face_packing_group_id field can indicate the identifier of a group of the frames. Accordingly, this field can represent that frames having the same cylinder_face_packing_group_id field value are generated from the same 360 video data, that is, the frames include the same 360 video data.

In addition, the cylinder_face_packing_last_seq field can indicate a sequence number of a finally transmitted frame among frames including the 360 video data when the 360 video data is included and transmitted in one or more frames. Further, the metadata can include a cylinder_face_packing_cur_seq field. The cylinder_face_packing_cur_seq field can indicate a sequence number of a current frame when the 360 video data is included and transmitted in one or more frames. For example, when the current frame is a frame transmitted first among frames including the 360 video data, the sequence number indicated by the cylinder_face_packing_cur_seq field can be 1. Further, the metadata can include a cylinder_face_number field. The cylinder_face_number field can indicate the number of regions representing cylinder faces included in the current frame. For example, the number of regions representing cylinder faces included in the current frame, indicated by the cylinder_face_number field, may be as shown in the following table.

TABLE 10

| Value | Interpretation |
|---|---|
| 0 | This can represent that the number of cylinder faces included |
| | in an image frame or which cylinder face is included is not defined. |
| 1 | This can represent that only one cylinder face is included in an |
| | image frame. |
| 2 | This can represent that 2 cylinder faces are included in an |
| | image frame. |
| 3 | This can represent that all cylinder faces are included in an |
| | image frame. |
| 4-7 | Reserved |

When the value of the cylinder_face_number field is 4 to 7, this can be used in the future.

When the value of the cylinder_face_number field is 0, the cylinder_face_number field can represent that the number of cylinder faces included in the current frame or which cylinder face is included in the frame is not defined.

Further, when the value of the cylinder_face_number field is 1, the cylinder_face_number field can represent that the number of cylinder faces included in the current frame is 1. That is, the cylinder_face_number field can represent that the current frame includes one region representing a cylinder face. For example, when the current frame includes only the side region of the cylinder, the cylinder_face_number field can be allocated to 1 and signaled and the cylinder_face_indicator field can be allocated to a value indicating the cylinder_side and signaled.

Further, when the value of the cylinder_face_number field is 2, the cylinder_face_number field can represent that the number of cylinder faces included in the current frame is 2. That is, the cylinder_face_number field can represent that the current frame includes 2 regions. For example, when the current frame includes the top region and the bottom region of the cylinder, the cylinder_face_number field can be allocated to 2 and signaled and the cylinder_face_indicator field can be allocated to a value indicating the cylinder_top and a value indicating the cylinder_bottom and signaled. That is, the cylinder_face_indicator indicating the cylinder_top and the cylinder_face_indicator indicating the cylinder_bottom can be signaled.

Further, when the value of the cylinder_face_number field is 3, the cylinder_face_number field can represent that the number of cylinder faces included in the current frame is 3. That is, the cylinder_face_number field can represent that the current frame includes 3 regions.

Meanwhile, when 360 video data projected on the basis of the cylindrical projection scheme is transmitted through a plurality of frames, a client/360 video reception apparatus can identify the start, continuation and end of a frame including the 360 video data through a sequence number derived on the basis of the aforementioned fields and thus can determine whether reception of the 360 video data is completed.

Meanwhile, although additional metadata with respect to 360 video data projected on the basis of the cubic projection scheme or the cylindrical projection scheme may be generated and signaled as described above, the same metadata with respect to projection and region-wise packing can be generated and signaled irrespective of the projection scheme applied thereto. In this case, the metadata can be generated and signaled for 360 video data projected on the basis of the octahedral projection scheme or the icosahedral projection scheme in addition to the cubic projection scheme or the cylindrical projection scheme. The metadata may be included and transmitted in an SEI (supplemental enhancement information) message or a VUI (video usability information) of an AVC NAL unit or HEVC NAL unit. When the video data is projected on the basis of a specific projection scheme, a 360 video reception apparatus can map and render data of a region representing each face of a specific 3D projection structure included in a frame to a 360 video space on the basis of the metadata.

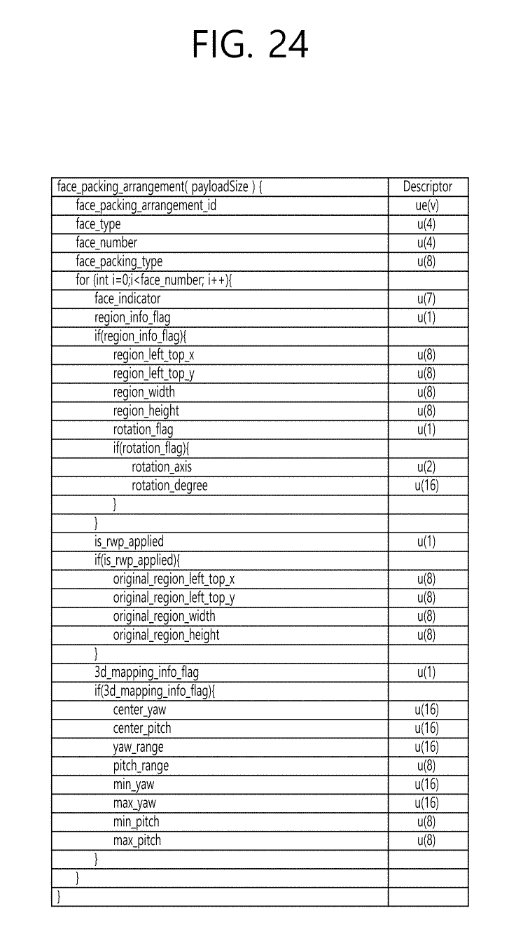

FIG. 24 illustrates metadata with respect to the projection and region-wise packing process. Referring to FIG. 24, the metadata can include a face_packing_arrangement_id field. The face_packing_arrangement_id field can indicate the identifier of a set of face_packing related fields signaled after the face_packing_arrangement_id field. In other words, the face_packing_arrangement_id field can indicate a set including face_packing related fields signaled after the face_packing_arrangement_id field.

In addition, referring to FIG. 24, the metadata can include a face_type field. The face_type field can indicate a type of faces constituting a 3D projection structure on which a 360 video is projected. That is, the face_type field can indicate a type of faces of a 3D projection structure of a projection scheme applied to projection of the 360 video data. The type of the faces may include a rectangle, a triangle, etc. For example, when the cubic projection scheme is applied to projection of the 360 video data, the face_type field can indicate a rectangle. As another example, when the octahedral projection scheme or the icosahedral projection scheme is applied to projection of the 360 video data, the face_type field can indicate a triangle.

In addition, referring to FIG. 24, the metadata can include a face_number field. The face_number field can indicate the number of regions representing faces of a specific 3D projection structure included in a current frame. Further, when the projection scheme applied to projection of the 360 video data is the cubic projection scheme, the face_number field can represent the same meaning as the aforementioned cube_face_number field. When the projection scheme applied to projection of the 360 video data is the cylindrical projection scheme, the face_number field can represent the same meaning as the aforementioned cylinder_face_number field. In addition, when the projection scheme applied to projection of the 360 video data is the octahedral projection scheme, the face_number field can represent the same meaning as an octahedron_face_number field. When the projection scheme applied to projection of the 360 video data is the icosahedral projection scheme, the face_number field can represent the same meaning as an icosahedron_face_number field. Here, the octahedron_face_number field can indicate the number of regions representing the faces of an octahedron included in a current frame. Further, the icosahedron_face_number field can indicate the number of regions representing the faces of an icosahedron included in a current frame.

In addition, referring to FIG. 24, the metadata can include a face_packing_type field. The face_packing_type field can indicate how regions representing faces of a specific 3D projection structure are arranged in a frame. In other words, the face_packing_type field can indicate a type in which regions representing the faces of the specific 3D projection structure are arranged in the frame. Further, when the projection scheme applied to projection of the 360 video data is the cubic projection scheme, the face_packing_type field can represent the same meaning as the aforementioned cube_face_packing_type field. When the projection scheme applied to projection of the 360 video data is the cylindrical projection scheme, the face_packing_type field can represent the same meaning as the aforementioned cylinder_face_packing_type field.

Furthermore, when the projection scheme applied to projection of the 360 video data is the octahedral projection scheme, the face_packing_type field can represent the same meaning as an octahedron_face_packing_type field. When the projection scheme applied to projection of the 360 video data is the icosahedral projection scheme, the face_packing_type field can represent the same meaning as an icosahedron_face_packing_type field. Here, the octahedron_face_packing_type field can represent how regions representing the faces of an octahedron are arranged in a frame. In other words, the octahedron_face_packing_type field can indicate a type in which the regions representing the faces of the octahedron are arranged in the frame. Specifically, the octahedron_face_packing_type field can indicate the numbers of columns and rows in which the regions representing the faces of the octahedron are arranged. In addition, the icosahedron_face_packing_type field can represent how regions representing the faces of an icosahedron are arranged in a frame. In other words, the icosahedron_face_packing_type field can indicate a type in which the regions representing the faces of the icosahedron are arranged in the frame. Specifically, the icosahedron_face_packing_type field can indicate the numbers of columns and rows in which the regions representing the faces of the icosahedron are arranged.

In addition, referring to FIG. 24, the metadata can include a face_indicator field. The face_indicator field can indicate a mapping relationship between a specific region of a frame and a specific face of a specific 3D projection structure. That is, the face_indicator field can indicate a face of the specific 3D projection structure indicated by the specific region of the frame. In addition, when the projection scheme applied to projection of the 360 video data is the cubic projection scheme, the face_indicator field can represent the same meaning as the aforementioned cube_face_indicator field. When the projection scheme applied to projection of the 360 video data is the cylindrical projection scheme, the face_indicator field can represent the same meaning as the aforementioned cylinder_face_indicator field.

Further, when the projection scheme applied to projection of the 360 video data is the octahedral projection scheme, the face_indicator field can represent the same meaning as an octahedron_face_indicator field. When the projection scheme applied to projection of the 360 video data is the icosahedral projection scheme, the face_indicator field can represent the same meaning as an icosahedron_face_indicator. Here, the octahedron_face_indicator field can indicate a mapping relationship between a specific region of a frame and a specific face of an octahedron. Further, the icosahedron_face_indicator field can indicate a mapping relationship between a specific region of a frame and a specific face of an icosahedron.

In addition, referring to FIG. 24, the metadata can include a region_info_flag field. The region_info_flag field can indicate whether the metadata includes information about a mapping area of a specific region representing a specific face of a specific 3D projection structure derived using the face_indicator field. That is, the region_info_flag field can indicate whether the metadata includes information about the position of the specific region in the frame. The information about the mapping area of the specific region can include coordinate values of the top-left pixel of the specific region and information representing the width and the height of the specific region. For example, the information about the mapping area can include a region_left_top_x field, a region_left_top_y field, a region_width field and a region_height field. The region_left_top_x field, the region_left_top_y field, the region_width field and the region_height field can be included in the metadata when the value of the region_info_flag field is 1.

Since even the same face of a specific 3D projection structure may be mapped to regions having different sizes in a frame according to importance of the face, information about a region mapped to each face, that is, the region_left_top_x field, the region_left_top_y field, the region_width field and the region_height field can be signaled. Accordingly, a reception side can derive a face of the specific 3D projection scheme mapped to the specific region more accurately and re-project data mapped to the specific region on spherical coordinates of the 3D space more accurately.

Specifically, the region_left_top_x field can indicate an x coordinate of the top-left pixel of a specific region mapped to a specific face of the specific 3D projection structure in the frame, which is derived using the face_indicator field. Further, the region_left_top_y field can indicate a y coordinate of the top-left pixel of the specific region mapped to the specific face of the specific 3D projection structure in the frame, which is derived using the face_indicator field. Further, the region_width field can indicate the width of the specific region mapped to the specific face of the specific 3D projection structure in the frame, which is derived using the face_indicator field. The width can be indicated in unit of pixel. Further, the region_height field can indicate the height of the specific region mapped to the specific face of the specific 3D projection structure in the frame, which is derived using the face_indicator field. The height can be indicated in unit of pixel.

In addition, referring to FIG. 24, the metadata can include a rotation_flag field. The rotation_flag field is a flag indicating whether rotation is applied to a specific region representing a specific face of the specific 3D projection structure when the specific region is projected on the frame. The rotation can be included in the region-wise packing process. When the value of the rotation_flag field is true, that is, when the value of the rotation_flag field is 1, the field can indicate that rotation is applied to the specific region when the specific region is projected.

When the value of the rotation_flag field is 1, the metadata can include a rotation_axis field and/or a rotation_degree field. The region_rotation_axis field can represent a reference axis that is a reference of rotation when the specific region is rotated and projected. The reference axis can include the upward direction of the vertical axis of the frame, the downward direction of the vertical axis, the left direction of the horizontal axis or the right direction of the horizontal axis. That is, the region rotation-axis field can indicate a reference axis that is a reference of rotation applied to the specific region among the upward direction of the vertical axis of the frame, the downward direction of the vertical axis, the left direction of the horizontal axis and the right direction of the horizontal axis. Further, the rotation_degree field can indicate an angle rotated clockwise on the basis of the reference axis. Here, the value of the angle may increase clockwise or may be in a range of 0 to 360 degrees.

In addition, referring to FIG. 24, the metadata can include an is_rwp_applied field. The is_rwp_applied field is a flag indicating whether region-wise packing has been applied to a frame on which the 360 video data is projected. The region-wise packing can refer to a process of dividing the frame on which the 360 video data is projected into regions and rotating and rearranging the regions or changing the resolution of each region. When the region-wise packing is applied to the projected frame, the value of the is_rwp_applied field can be true. That is, the value of the is_rwp_applied field can be 1.

When the value of the is_rwp_applied field is 1, the metadata can include an original_region_left_top_x field, an original_region_left_top_y field, an original_region_width field and an original_region_height field.

Specifically, the original_region_left_top_x field can indicate an x coordinate of the top-left pixel of a specific region in the projected frame mapped to the top-left pixel of the specific region in the current frame, that is, the packed frame. In other words, the original_region_left_top_x field can indicate the x coordinate of the top-left pixel of the specific region in the projected frame.

In addition, the original_region_left_top_y field can indicate a y coordinate of the top-left pixel of the specific region in the projected frame mapped to the top-left pixel of the specific region in the current frame, that is, the packed frame. In other words, the original_region_left_top_y field can indicate the y coordinate of the top-left pixel of the specific region in the projected frame.

The original_region_width field can indicate the width of the specific region in the projected frame mapped to the top-left pixel of the specific region in the current frame, that is, the packed frame. In other words, the original_region_width field can indicate the width of the specific region in the projected frame. The width can be represented in unit of pixel.

The original_region_height field can indicate the height of the specific region in the projected frame mapped to the top-left pixel of the specific region in the current frame, that is, the packed frame. In other words, the original_region_height field can indicate the height of the specific region in the projected frame. The height can be represented in unit of pixel.

In addition, referring to FIG. 24, the metadata can include a 3d_mapping_info_flag field. The 3d_mapping_info_flag field is a flag indicating presence or absence of information about a region in spherical coordinates of the 3D space which is matched to a region representing each face of a specific 3D projection structure. When the value of the 3d_mapping_info_flag field with respect to a specific region representing a specific face of the 3D projection structure is true, that is, the value of the 3d_mapping_info_flag field is 1, the metadata can include a center_yaw field, a center_pitch field, a yaw_range field, a pitch_range field, a min_yaw field, a max_yaw field, a min_pitch field and/or a max_pitch field with respect to the specific region.

The center_yaw field can indicate a yaw angle value of a point on the spherical coordinates in the frame, which is mapped to the center pixel of the region representing the specific face of the 3D projection structure. Further, the center_pitch field can indicate a pitch angle value of the point on the spherical coordinates in the frame, which is mapped to the center pixel of the region representing the specific face of the 3D projection structure. Further, the min_yaw field can indicate a minimum yaw angle value of the region on the spherical coordinates mapped to the region representing the specific face in the frame. Further, the max_yaw field can indicate a maximum yaw angle value of the region on the spherical coordinates mapped to the region representing the specific face in the frame. Further, the min_pitch field can indicate a minimum pitch angle value of the region on the spherical coordinates mapped to the region representing the specific face in the frame. Further, the max_pitch field can indicate a maximum pitch angle value of the region on the spherical coordinates mapped to the region representing the specific face in the frame. Further, the yaw_range field can indicate a yaw angle range of the region on the spherical coordinates mapped to the region representing the specific face in the frame. A specific value of the yaw angle range can be derived through the center_yaw field and the yaw_range field, and the yaw angle range of the region on the spherical coordinates may be center_yaw−yaw_range/2 to center_yaw+yaw_range/2. Further, the pitch_range field can indicate a pitch angle range of the region on the spherical coordinates mapped to the region representing the specific face in the frame. A specific value of the pitch angle range can be derived through the center_pitch field and the pitch_range field, and the pitch angle range of the region on the spherical coordinates may be center_pitch−pitch_range/2 to center_pitch+pitch_range/2.

When data is selectively received according to view of a user, a 360 video reception apparatus can determine whether to receive and process a corresponding frame through the aforementioned face_number field and face_indicator field or the aforementioned information about a region on the spherical coordinates of the 3D space.

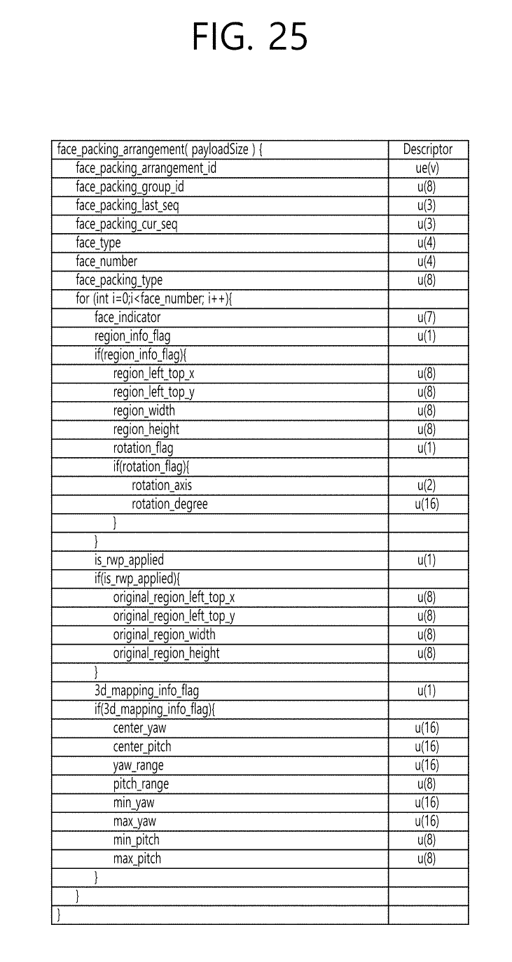

Although 360 video data can be included in one frame and signaled, the 360 video data may be included in a plurality of frames and signaled. In this case, metadata with respect to projection and region-wise packing may be signaled as shown in FIG. 25.

FIG. 25 shows an example of metadata with respect to projection and region-wise packing. Referring to FIG. 25, the metadata can include the aforementioned face_packing_arrangement_id field, face_type field, face_number field, face_packing_type field, face_indicator field, region_info_flag field, region_left_top_x field, region_left_top_y field, region_width field, region_height field, rotation_flag field, rotation_axis field, rotation_degree field, is_rwp_applied field, original_region_left_top_x field, original_region_left_top_y field, original_region_width field, original_region_height field, 3d_mapping_info_flag field, center_yaw field, center_pitch field, yaw_range field, pitch_range field, min_yaw field, max_yaw field, min_pitch field and/or max_pitch field. The meanings of these fields have been described above.

In addition, the metadata can include a face_packing_group_id field. When 360 video data is included and transmitted in one or more consecutive frames, the face_packing_group_id field can indicate the identifier of a group of the frames. Accordingly, this field can indicate that frames having the same face_packing_group_id field value are generated from the same 360 video data, that is, include the same 360 video data.

Furthermore, the metadata can include a face_packing_last_seq field. The face_packing_last_seq field can indicate the sequence number of a finally transmitted frame among frames including 360 video data when the 360 video data is included and transmitted in one or more frames. In addition, the metadata can include a face_packing_cur_seq field. The face_packing_cur_seq field can indicate the sequence number of the current frame when the 360 video data is included and transmitted in one or more frames. For example, when the current frame is a frame transmitted first among the frames including the 360 video data, the sequence number indicated by the face_packing_cur_seq field can be 1.

When 360 video data is transmitted through a plurality of consecutive frames, a client/360 video reception apparatus can identify the start, continuation and end of a frame including the 360 video data through a sequence number derived on the basis of the aforementioned fields and thus can determine whether reception of the 360 video data is completed.

Meanwhile, OMVInformationSEIBox that can be included in a file format such as ISOBMFF may be newly defined in order to deliver the metadata with respect to 360 video. The OMVInformationSEIBox can include an SEI NAL unit including the aforementioned metadata with respect to 360 video. The SEI NAL unit can include an SEI message including the 360 video related metadata. OMVInformationSEIBox 1820 can be included and delivered in VisualSampleEntry, AVCSampleEntry, MVCSampleEntry, SVCSampleEntry, HEVCSampleEntry or the like.

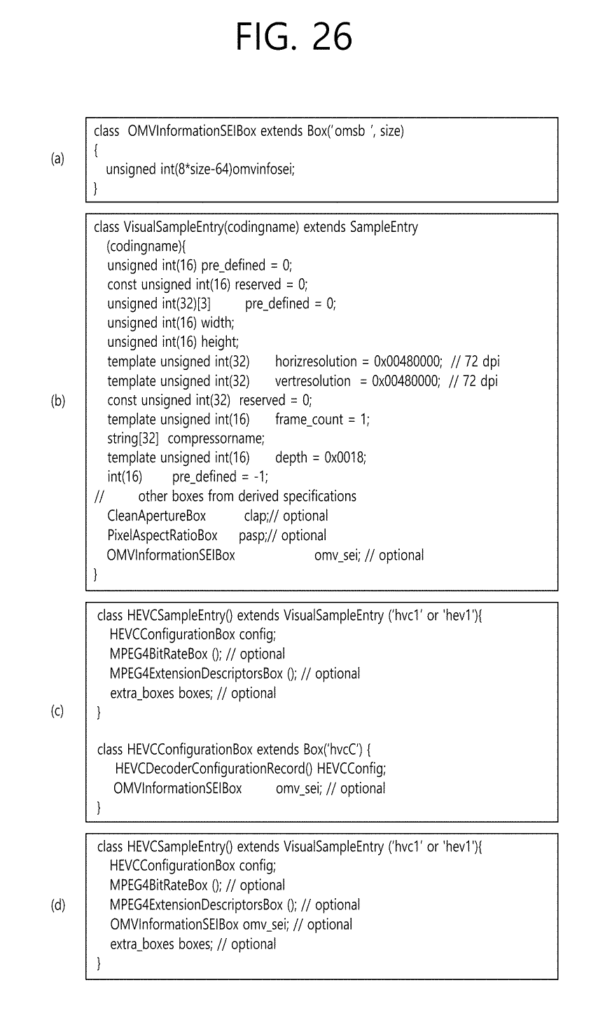

FIG. 26 illustrates the OMVInformationSEIBox included and transmitted in VisualSampleEntry or HEVCSampleEntry. Referring to FIG. 26(a), the OMVInformationSEIBox can include an omvinfosei field. The omvinfosei field can include an SEI NAL unit including the aforementioned metadata with respect to 360 video. The metadata has been described.

In addition, the OMVInformationSEIBox may be included and transmitted in VisualSampleEntry, AVCSampleEntry, MVCSampleEntry, SVCSampleEntry, HEVCSampleEntry or the like.

For example, referring to FIG. 26(b), the OMVInformationSEIBox may be included and transmitted in the VisualSampleEntry. The VisualSampleEntry can include an omv_sei field indicating whether the OMVInformationSEIBox is applied. When the omv_sei field indicates that the OMVInformationSEIBox is applied to the VisualSampleEntry, the metadata with respect to 360 video included in the OMVInformationSEIBox can be copied and applied to the VisualSampleEntry.

In addition, referring to FIG. 26(c), the OMVInformationSEIBox may be included and transmitted in HEVCDecoderConfigurationRecord of the HEVCSampleEntry. HEVCDecoderConfigurationRecord of the HEVCSampleEntry can include an omv_sei field indicating whether the OMVInformationSEIBox is applied. When the omv_sei field indicates that the OMVInformationSEIBox is applied to the HEVCDecoderConfigurationRecord, the metadata with respect to 360 video included in the OMVInformationSEIBox can be copied and applied to the HEVCDecoderConfigurationRecord.

In addition, referring to FIG. 26(d), the OMVInformationSEIBox may be included and transmitted in the HEVCSampleEntry. The HEVCSampleEntry can include an omv_sei field indicating whether the OMVInformationSEIBox is applied. When the omv_sei field indicates that the OMVInformationSEIBox is applied to the HEVCSampleEntry, the metadata with respect to 360 video included in the OMVInformationSEIBox can be copied and applied to the HEVCSampleEntry.

Meanwhile, the OMVInformationSEIBox may include SEI (Supplemental enhancement information) or VUI (Video Usability Information) including the aforementioned projection or region-wise packing related fields. Through this information, information about how a specific region mapped to 360 video in a frame has been packed can be signaled.

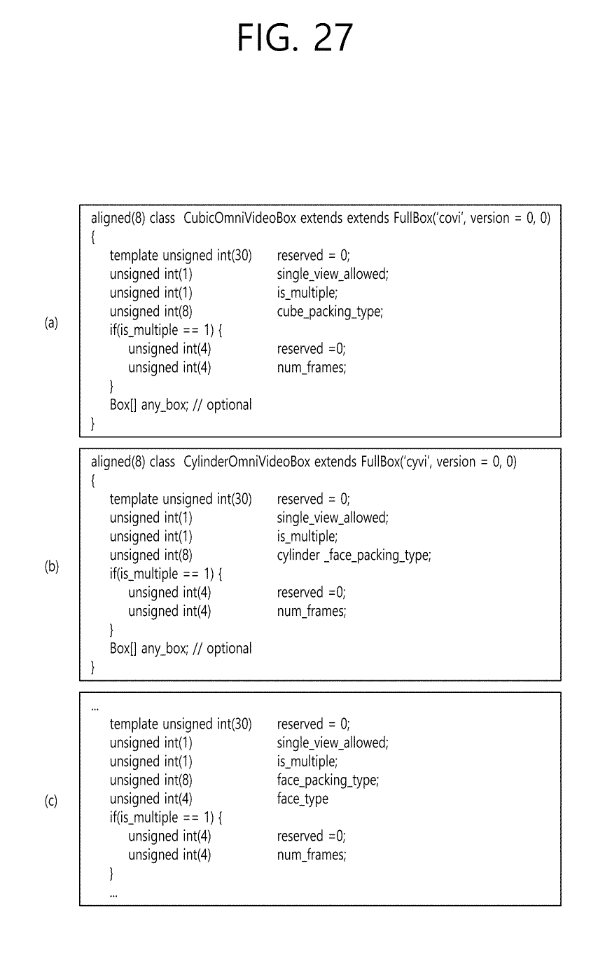

FIG. 27 illustrates a method of signaling information about how a specific region has been packed when a 360 video projected on the basis of a specific projection scheme is included in a file format. FIG. 27(a) shows a CubicOmniVideoBox including information about packing of the specific region when a 360 video projected on the basis of the cubic projection scheme is included. The CubicOmniVideoBox can include a single_view_allowed field. The single_view_allowed field is a flag indicating whether each cube face can be independently decoded, rendered and/or displayed. In addition, the CubicOmniVideoBox can include an is_multiple field. The is_multiple field is a flag indicating whether 360 video data is stored or transmitted through a plurality of frames. For example, the is_multiple field can indicate that the 360 video data is mapped to one frame and stored or transmitted therethrough when set to 0 and indicate that the 360 video data is stored or transmitted through one or more frames adjacent to the corresponding frame when set to 1.

In addition, the CubicOmniVideoBox can include a cube_packing_type field. The cube_packing_type field can indicate how regions representing cube faces included in the corresponding frame are arranged. In other words, the cube_packing_type field can indicate the numbers of columns and rows in which the regions are arranged.

Further, the CubicOmniVideoBox can include a num_frames field. The num_frames field can indicate the number of frames adjacent to the corresponding frame in which the 360 video data is stored or transmitted when the 360 video data is stored or transmitted through one or more frames adjacent to the corresponding frame, that is, when the value of the is_multiple field is 1.

FIG. 27(b) shows a CylinderOmniVideoBox including information about packing of the specific region when 360 video projected on the basis of the cylindrical projection scheme is included. The CylinderOmniVideoBox can include a single_view_allowed field, an is_multiple field, a cylinder_face_packing_type field and/or a num_frames field. The single_view_allowed field is a flag indicating whether each cylinder face can be independently decoded, rendered and/or displayed, and the cylinder_face_packing_type field can indicate how regions representing cylinder faces included in the corresponding frame are arranged. Further, the meanings of the num_frames field and the is_multiple field have been described above.

FIG. 27(c) shows an example of signaling information about packing of the specific region through a file format irrespective of a projection scheme. In this case, the file format may include a single_view_allowed field, an is_multiple field and a num_frames field. The meanings of these fields have been described above. Further, the file format may include a face_packing_type field which indicate how regions included in a frame are arranged. In addition, the file format may include a face_type field. The face_type field can indicate the shape of the regions, that is, indicate whether the regions have a triangular or rectangular shape.

In addition, the aforementioned projection or region-wise packing related fields included in the SEI or VUI may be included in a box in the file format which is not shown in FIG. 27.

Meanwhile, when a broadcast service for 360 video is provided through the DASH based adaptive streaming model or a 360 video is streamed through the DASH based adaptive streaming model, the above-described fields of metadata for 360 video can be signaled in a DASH based descriptor format included in a DASH MPD. That is, the above-described embodiments with respect to metadata for 360 video can be modified in the DASH based descriptor format. The DASH based descriptor format can include an EssentialProperty descriptor and a SupplementalProperty descriptor. A descriptor representing the aforementioned fields of metadata for 360 video can be included in AdaptationSet, Representation or SubRepresentation of the MPD. Accordingly, a client or a 360 video reception apparatus can acquire projection or region-wise packing related fields and process 360 video on the basis of the fields.

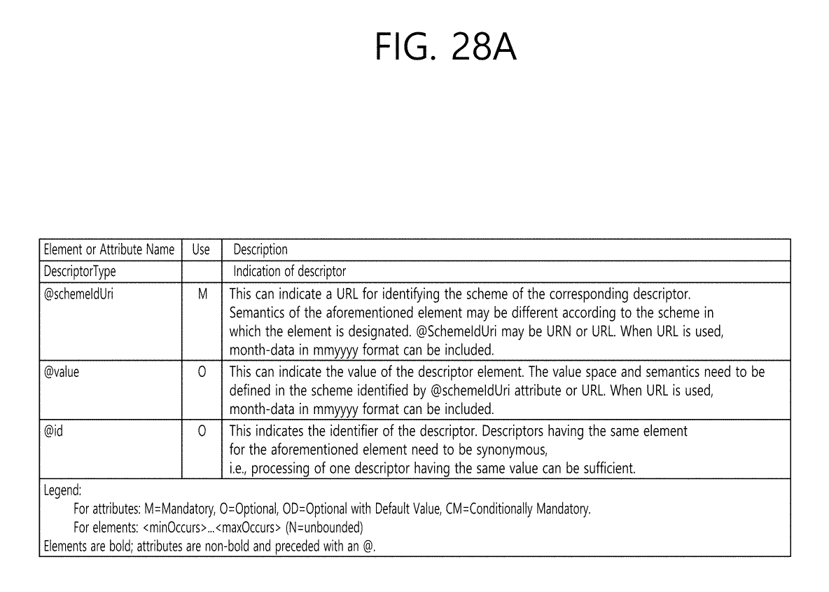

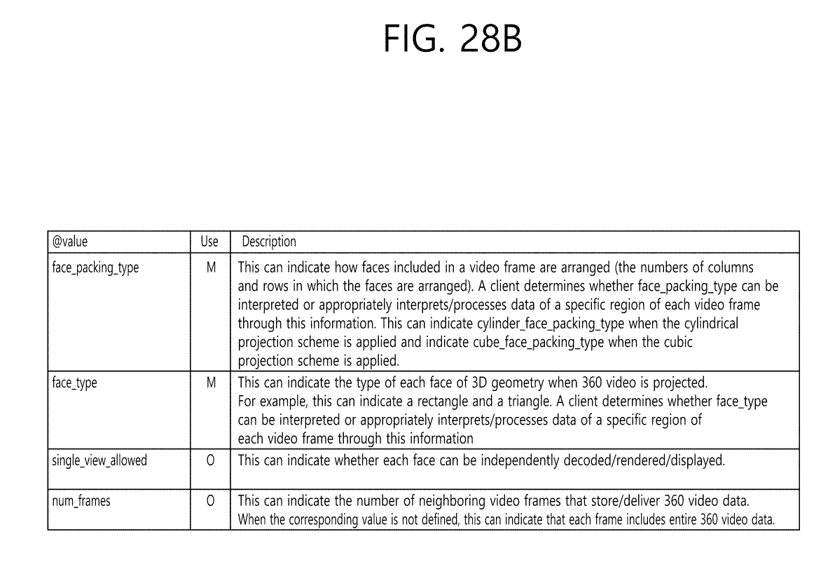

FIGS. 28a and 28b show an example of metadata with respect to 360 video described in the form of a DASH based descriptor. As shown in FIG. 28a, the DASH based descriptor may include an @schemeIdUri field, an @value field and/or an @id field. The @schemeIdUri field can provide a URI for identifying the scheme of the corresponding descriptor. The @value field can have a value defined by the scheme indicated by the @schemeIdUri field. That is, the @value field may have values of descriptor elements according to the corresponding scheme, and the values may be referred to as parameters. The parameters may be distinguished by ‘,’. The @id can indicate the identifier of the corresponding descriptor. When descriptors have the same identifier, the descriptors can include the same scheme ID, value and parameters.

In addition, the @schemeIdURI field can have a value of urn:mpeg:dash:vr:facepacking:201x in order to represent a descriptor delivering metadata with respect to 360 video. This may be a value identifying that the corresponding descriptor is a descriptor delivering metadata with respect to 360 video. Further, when metadata with respect to 360 video to which the cubic projection scheme has been applied is transmitted, the @schemeIdURI field can have a value of urn:mpeg:dash:vr:cubic:201x. In addition, when metadata with respect to 360 video to which the cylindrical projection scheme has been applied is transmitted, the @schemeIdURI field can have a value of urn:mpeg:dash:vr:cylinder:201x. In addition, the @schemeIdURI field may have other values.

The @value field of the descriptor delivering the metadata with respect to 360 video may have values as shown in FIG. 28b. That is, parameters distinguished by ‘,’ of @value can correspond to the above-described fields included in the metadata with respect to 360 video. Although FIG. 28b describes one of various embodiments of the above-described metadata with respect to 360 video using parameters of @value, each field may be replaced by a parameter to describe embodiments of the above-described metadata with respect to 360 video using parameters of @value. That is, the above-described metadata with respect to 360 video according to all of the embodiments may be described in the form of a DASH based descriptor.

In FIG. 28b, each parameter can have the same meaning as that of the field in the same name. Here, M can mean that the corresponding parameter is mandatory, 0 can mean that the corresponding parameter is optional and OD can mean that the corresponding parameter is optional with default. When an OD parameter is not provided, a predefined default value may be used as the corresponding parameter value. In the illustrated embodiment, a default value of each OD parameter is given in a parenthesis.

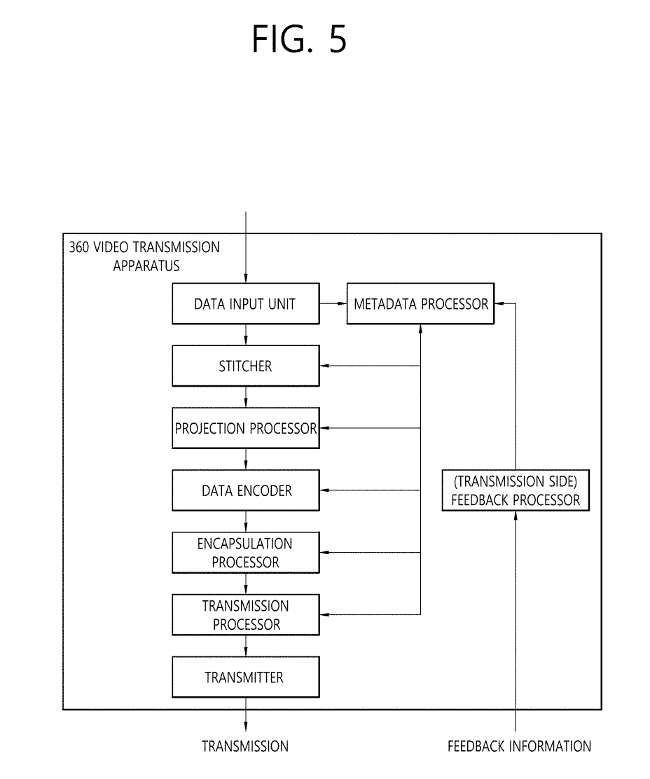

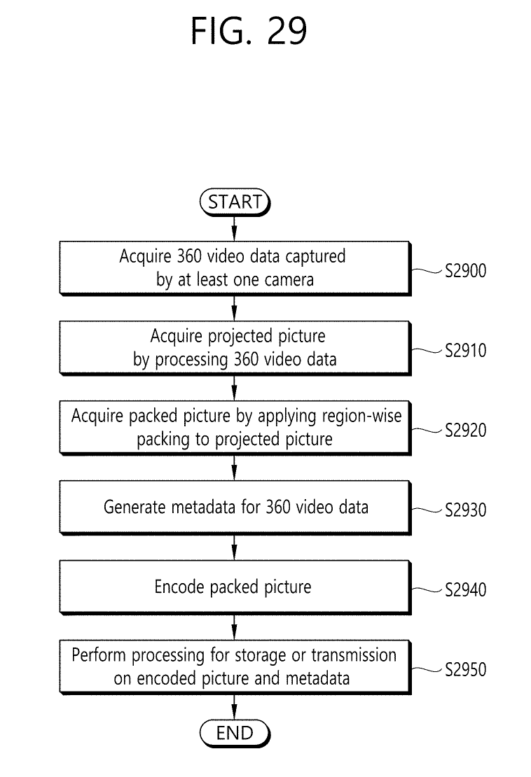

FIG. 29 schematically shows a 360 video data processing method performed by a 360 video transmission apparatus according to the present invention. The method illustrated in FIG. 29 may be performed by the 360 video transmission apparatus illustrated in FIG. 5. Specifically, S2900 of FIG. 29 can be performed by the data input unit of the 360 video transmission apparatus, S2910 can be performed by the projection processor of the 360 video transmission apparatus, S2920 can be performed by the region-wise packing processor of the 360 video transmission apparatus, S2930 can be performed by the metadata processor of the 360 video transmission apparatus, S2940 can be performed by the data encoder of the 360 video transmission apparatus and S2950 can be performed by the transmission processor of the 360 video transmission apparatus, for example. The transmission processor can be included in the transmitter.

The 360 video transmission apparatus acquires 360 video data captured by at least one camera (S2900). The 360 video transmission apparatus may acquire 360 video data captured by at least one camera. The 360 video data may be a video captured by at least one camera.

The 360 video transmission apparatus processes the 360 video data to acquire a projected picture (S2910). The 360 video transmission apparatus may perform projection on a 2D image according to a projection scheme for the 360 video data among various projection schemes to acquire a projected picture. The various projection schemes may include an equirectangular projection scheme, a cubic projection scheme, a cylindrical projection scheme, a tile-based projection scheme, a pyramid projection scheme, a panoramic projection scheme and the aforementioned specific scheme for projection on a 2D image without stitching. Further, the projection schemes may include an octahedral projection schemes and an icosahedral projection scheme. When projection scheme information indicates the specific scheme, the at least one camera may be a fish-eye camera. In this case, an image acquired by each camera may be a circular image. The projected picture may include regions representing faces of a 3D projection structure of the projection scheme. For example, the regions may have a rectangular shape when the projection scheme for the 360 video data is the cubic projection scheme and may have a triangular shape when the projection scheme for the 360 video data is the octahedral projection scheme. Further, the 360 video data may be processed to acquire a plurality of projected pictures. That is, the 360 video data may be delivered through a plurality of projected pictures. The projected pictures may be consecutive pictures in processing order. Here, the projected picture may also be called a projected frame.

The 360 video transmission apparatus applies region-wise packing to the projected picture to acquire a packed picture (S2920). The 360 video transmission apparatus may perform processing such as rotating and rearranging the regions of the projected picture or changing the resolution of each region. The processing procedure may be called a region-wise packing process. The 360 video transmission apparatus may apply the region-wise packing process to the projected picture and acquire the packed picture including regions to which the region-wise packing process has been applied. The packed picture may be referred to as a packed frame.

The 360 video transmission apparatus generates metadata with respect to the 360 video data (S2930). The metadata may include the aforementioned face_packing_arrangement_id field, face_packing_group_id field, face_packing_last_seq field, face_packing_cur_seq field, face_type field, face_number field, face_packing_type field, face_indicator field, region_info_flag field, region_left_top_x field, region_left_top_y field, region_width field, region_height field, rotation_flag field, rotation_axis field, rotation_degree field, is_rwp_applied field, original_region_left_top_x field, original_region_left_top_y field, original_region_width field, original_region_height field, 3d_mapping_info_flag field, center_yaw field, center_pitch field, yaw_range field, pitch_range field, min_yaw field, max_yaw field, min_pitch field and/or max_pitch field. Further, the metadata may include the vertical_flipped field and the horizontal_flipped field. The definitions of these fields have been described above.

Specifically, the metadata may include 3D mapping information about each of the aforementioned regions and the 3D mapping information about each region may represent a yaw value and a pitch value of spherical coordinates of a spherical surface corresponding to the center of the region. Further, the 3D mapping information may further represent a yaw range and a pitch range of a region on the spherical surface corresponding to the region and further represent a maximum yaw value, a minimum yaw value, a maximum pitch value and a minimum pitch value. For example, the 3D mapping information may be represented by the aforementioned center_yaw field, center_pitch field, yaw_range field, pitch_range field, min_yaw field, max_yaw field, min_pitch field and/or max_pitch field. Further, the metadata may include a 3D mapping information flag indicating presence or absence of the 3D mapping information. When the 3D mapping information flag indicates presence of the 3D mapping information, the metadata can include the 3D mapping information. The 3D mapping information flag can indicate the aforementioned 3d_mapping_info_flag field.

Alternatively, the metadata may include a packing application flag indicating whether the region-wise packing process is applied to each region. The packing application flag can represent the aforementioned is_rwp_applied field. When the packing application flag indicates that the region-wise packing process is applied to a packing target region associated with the flag, the metadata can include information about x- and y-coordinate values of the top-left pixel of the packing target region on the projected picture. Further, the metadata may include information about the width and the height of the packing target region on the projected picture. The information about the x- and y-coordinate values of the top-left pixel of the packing target region on the projected picture can represent the original_region_left_top_x field and the original_region_left_top_y field, and the information about the width and the height of the packing target region on the projected picture can represent the original_region_width field and the original_region_height field.

Alternatively, the metadata may include information representing the type of faces corresponding to the regions or the type of the regions, information representing the number of faces or regions, and information representing arrangement of the faces or the regions on the packed picture. The 360 video data may be mapped to one or more faces according to projection format. For example, the information representing the type of the faces or the regions can indicate a rectangle when the projection format with respect to the projected picture indicates cubic projection and indicate a triangle when the projection format with respect to the projected picture indicates octahedral projection or icosahedral projection. The information representing the type of the faces or the regions can represent the aforementioned face_type field, the information representing the number of faces or regions can represent the aforementioned face_number field and the information representing arrangement of the faces or the regions on the packed picture can represent the aforementioned face_packing_type field.

Alternatively, the 360 video data may be delivered through a plurality of packed pictures. In this case, the metadata may include information representing a group including the plurality of packed pictures, information indicating the processing order of the picture that finally delivers the 360 video data among the packed picture, and information indicating processing order of each picture. The information representing the plurality of packed pictures can represent the aforementioned face_packing_group_id field, the information indicating the processing order of the picture that finally delivers the 360 video data among the packed picture can represent the aforementioned face_packing_last_seq field, and the information indicating processing order of each picture can represent the aforementioned face_packing_cur_seq field.

Alternatively, the metadata may include region information about a region. The region information can indicate x- and y-coordinate values of the top-left pixel of the region associated with a face according to projection format. Further, the region information can indicate the width and the height of the region. Further, the region information may include a rotation flag indicating whether the region is rotated. The region information can indicate a rotation reference axis and a rotated angle when the rotation flag is 1. The rotation flag can represent the aforementioned rotation_flag field, and the region information can be represented through the aforementioned region_left_top_x field, region_left_top_y field, region_width field, region_height field, rotation_flag field, rotation_axis field and/or rotation_degree field. Further, the metadata may include a region information flag indicating presence or absence of the region information. When the region information flag indicates presence of the region information, the metadata can include the region information. The region information flag can represent the aforementioned region_info_flag.

Meanwhile, the metadata may be transmitted through an SEI message. The metadata may be included in AdaptationSet, Representation or SubRepresentation of MPD (Media Presentation Description). Here, the SEI message may be used to assist decoding of a 2D image or display of the 2D image on a 3D space.

The 360 video transmission apparatus encodes the packed picture (S2940). The 3D video transmission apparatus may encode the packed picture. Further, the 3D video transmission apparatus may encode the metadata.

The 3D video transmission apparatus performs a process for storing or transmitting the encoded picture and the metadata (S2950). The 3D video transmission apparatus may encapsulate the encoded 360 video data and/or the metadata in the form of a file. The 3D video transmission apparatus may encapsulate the encoded 360 video data and/or the metadata in a file format such as ISOBMFF or CFF in order to store or transmit the encoded 360 video data and/or the metadata or process the encoded 360 video data and/or the metadata into a DASH segment and the like. The 3D video transmission apparatus may include the metadata in a file format. For example, the metadata may be included in a box with various levels in ISOBMFF or included in a file as data in a separate track. In addition, the 3D video transmission apparatus may encapsulate the metadata into a file. The 3D video transmission apparatus may apply processing for transmission to the encapsulated 360 video data according to file format. The 3D video transmission apparatus may process the 360 video data according to an arbitrary transmission protocol. Processing for transmission may include processing for delivery through a broadcast network or processing for delivery through a communication network such as a broadband. Further, the 3D video transmission apparatus may apply processing for transmission to the metadata. The 3D video transmission apparatus may transmit the processed 360 video data and metadata through a broadcast network and/or a broadband.

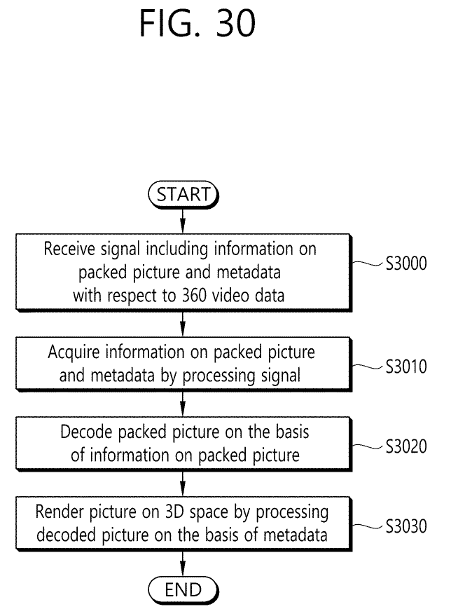

FIG. 30 schematically shows a 360 video data processing method performed by a 360 video reception apparatus according to the present invention. The method illustrated in FIG. 30 may be performed by the 360 video reception apparatus illustrated in FIG. 6. Specifically, S3000 of FIG. 30 can be performed by the receiver of the 360 video reception apparatus, S3010 can be performed by the reception processor of the 360 video reception apparatus, S3020 can be performed by the data decoder of the 360 video reception apparatus and S3030 can be performed by the renderer of the 360 video reception apparatus.

The 360 video reception apparatus receives a signal including information about a packed picture with respect to 360 video data and metadata with respect to the 360 video data (S3000). The 360 video reception apparatus may receive the information about the packed picture with respect to the 360 video data and the metadata signaled from a 360 video transmission apparatus through a broadcast network. The 360 video data may be received through a plurality of packed pictures. The plurality of packed pictures may be consecutive pictures in processing order. Further, the 360 video reception apparatus may receive the information about the packed information and the metadata through a communication network such as a broadband or a storage medium. Here, the packed picture may also be called a packed frame.

The 360 video reception apparatus processes the received signal to acquire the information about the packed picture and the metadata (S3010). The 360 video reception apparatus may perform processing according to a transmission protocol on the received information about the packed picture and the metadata. Further, the 360 video reception apparatus may perform a process reverse to the aforementioned process for transmission of the 360 video transmission apparatus. The metadata may include the aforementioned face_packing_arrangement_id field, face_packing_group_id field, face_packing_last_seq field, face_packing_cur_seq field, face_type field, face_number field, face_packing_type field, face_indicator field, region_info_flag field, region_left_top_x field, region_left_top_y field, region_width field, region_height field, rotation_flag field, rotation_axis field, rotation_degree field, is_rwp_applied field, original_region_left_top_x field, original_region_left_top_y field, original_region_width field, original_region_height field, 3d_mapping_info_flag field, center_yaw field, center_pitch field, yaw_range field, pitch_range field, min_yaw field, max_yaw field, min_pitch field and/or max_pitch field. Further, the metadata may include the vertical_flipped field and the horizontal_flipped field. The definitions of these fields have been described above.

Specifically, the metadata may include 3D mapping information about each of regions of the 2D based picture, and the 3D mapping information about each region may represent a yaw value and a pitch value of spherical coordinates of a spherical surface corresponding to the center of the region. Further, the 3D mapping information may further represent a yaw range, a pitch range, a maximum yaw value, a minimum yaw value, a maximum pitch value and a minimum pitch value of a region on the spherical surface corresponding to the region. For example, the 3D mapping information may be represented by the aforementioned center_yaw field, center_pitch field, yaw_range field, pitch_range field, min_yaw field, max_yaw field, min_pitch field and/or max_pitch field. Further, the metadata may include a 3D mapping information flag indicating presence or absence of the 3D mapping information. When the 3D mapping information flag indicates presence of the 3D mapping information, the metadata can include the 3D mapping information. The 3D mapping information flag can indicate the aforementioned 3d_mapping_info_flag field.

Alternatively, the metadata may include a packing application flag indicating whether the region-wise packing process is applied to each region. The packing application flag can represent the aforementioned is_rwp_applied field. When the packing application flag indicates that the region-wise packing process is applied to a packing target region associated with the flag, the metadata can include information about x- and y-coordinate values of the top-left pixel of the packing target region on the projected picture. Further, the metadata may include information about the width and the height of the packing target region on the projected picture. The information about the x- and y-coordinate values of the top-left pixel of the packing target region on the projected picture can represent the original_region_left_top_x field and the original_region_left_top_y field, and the information about the width and the height of the packing target region on the projected picture can represent the original_region_width field and the original_region_height field.

Alternatively, the metadata may include information representing the type of faces corresponding to the regions or the type of the regions, information representing the number of faces or regions, and information representing arrangement of the faces or the regions on the packed picture. The 360 video data may be mapped to one or more faces according to projection format. For example, the information representing the type of the faces or the regions can indicate a rectangle when the projection format with respect to the projected picture indicates cubic projection and indicate a triangle when the projection format with respect to the projected picture indicates octahedral projection or icosahedral projection. The information representing the type of the faces or the regions can represent the aforementioned face_type field, the information representing the number of faces or regions can represent the aforementioned face_number field and the information representing arrangement of the faces or the regions on the packed picture can represent the aforementioned face_packing_type field.

Alternatively, the 360 video data may be received through a plurality of packed pictures. In this case, the metadata may include information representing a group including the plurality of packed pictures, information indicating the processing order of the picture that finally delivers the 360 video data among the packed picture, and information indicating processing order of each picture. The information representing the plurality of packed pictures can represent the aforementioned face_packing_group_id field, the information indicating the processing order of the picture that finally delivers the 360 video data among the packed picture can represent the aforementioned face_packing_last_seq field, and the information indicating processing order of each picture can represent the aforementioned face_packing_cur_seq field.

Alternatively, the metadata may include region information about a region. The region information can indicate x- and y-coordinate values of the top-left pixel of the region associated with a face according to projection format. Further, the region information can indicate the width and the height of the region. Further, the region information may include a rotation flag indicating whether the region is rotated. The region information can indicate a rotation reference axis and a rotated angle when the rotation flag is 1. The rotation flag can represent the aforementioned rotation_flag field, and the region information can be represented through the aforementioned region_left_top_x field, region_left_top_y field, region_width field, region_height field, rotation_flag field, rotation_axis field and/or rotation_degree field. Further, the metadata may include a region information flag indicating presence or absence of the region information. When the region information flag indicates presence of the region information, the metadata can include the region information. The region information flag can represent the aforementioned region_info_flag.

Meanwhile, the metadata may be received through an SEI message. The metadata may be included in AdaptationSet, Representation or SubRepresentation of MPD (Media Presentation Description). Here, the SEI message may be used to assist decoding of a 2D image or display of the 2D image on a 3D space.

The 360 video reception apparatus decodes the picture on the basis of the information about the picture (S3020). The 360 video reception apparatus may decode the picture on the basis of the information about the picture.

The 360 video reception apparatus processes the decoded picture on the basis of the metadata to render the picture on a 3D space (S3030). The 360 video reception apparatus may map the 360 video data of the packed picture to the 3D space on the basis of the metadata. Further, the 360 video reception apparatus may acquire a projected picture from the packed picture on the basis of the metadata and re-project the projected picture on the 3D space.

The above-described steps may be omitted according to an embodiment or replaced by other steps of performing similar/identical operations.

The 360 video transmission apparatus according to an embodiment of the present invention may include the above-described data input unit, stitcher, signaling processor, projection processor, data encoder, transmission processor and/or transmitter. The internal components have been described above. The 360 video transmission apparatus and internal components thereof according to an embodiment of the present invention may perform the above-described embodiments with respect to the method of transmitting a 360 video of the present invention.

The 360 video reception apparatus according to an embodiment of the present invention may include the above-described receiver, reception processor, data decoder, signaling parser, re-projection processor and/or renderer. The internal components have been described above. The 360 video reception apparatus and internal components thereof according to an embodiment of the present invention may perform the above-described embodiments with respect to the method of receiving a 360 video of the present invention.

The internal components of the above-described apparatuses may be processors which execute consecutive processes stored in a memory or hardware components. These components may be located inside/outside the apparatuses.

The above-described modules may be omitted or replaced by other modules which perform similar/identical operations according to embodiments.

The above-described parts, modules or units may be processors or hardware parts executing consecutive processes stored in a memory (or a storage unit). The steps described in the aforementioned embodiments can be performed by processors or hardware parts. Modules/blocks/units described in the above embodiments can operate as hardware/processors. The methods proposed by the present invention can be executed as code. Such code can be written on a processor-readable storage medium and thus can be read by a processor provided by an apparatus.

In the above exemplary systems, although the methods have been described based on the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means. The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices.

What is claimed is:

1. A 360-degree video data processing method performed by a 360 video transmission apparatus, comprising:
acquiring 360 video data captured by at least one camera;
acquiring a projected picture by processing the 360 video data;
acquiring a packed picture by applying region-wise packing to the projected picture;
generating metadata for the 360 video data;
encoding the packed picture; and
performing processing for storage or transmission on the encoded picture and the metadata,
wherein the metadata includes 3D mapping information on a region of the packed picture, and the 3D mapping information indicates a yaw value and a pitch value of spherical coordinates of a spherical surface corresponding to a center point of the region.

2. The 360-degree video data processing method according to claim 1, wherein the 3D mapping information further indicates a yaw range and a pitch range of a region on the spherical surface corresponding to the region.

3. The 360-degree video data processing method according to claim 1, wherein the 3D mapping information further indicates a maximum yaw value, a minimum yaw value, a maximum pitch value and a minimum pitch value of the region on the spherical surface corresponding to the region.

4. The 360-degree video data processing method according to claim 2, wherein the metadata includes a 3D mapping information flag indicating presence or absence of the 3D mapping information, and the metadata includes the 3D mapping information when the 3D mapping information flag indicates presence of the 3D mapping information.

5. The 360-degree video data processing method according to claim 1, wherein the metadata includes a packing application flag indicating whether the region-wise packing is applied, and the metadata includes information about an x-coordinate value and a y-coordinate value of the top-left pixel of the region on the projected picture when the packing application flag indicates that the region-wise packing is applied to the region.

6. The 360-degree video data processing method according to claim 5, wherein the metadata further includes information about the width and the height of the region on the projected picture.

7. The 360-degree video data processing method according to claim 1, wherein the 360 video data is mapped to one or more faces according to a projection format, and the metadata includes at least one of information indicating a type of a face corresponding to the region, information indicating the number of faces and information representing an arrangement type of the faces on the packed picture.

8. The 360-degree video data processing method according to claim 7, wherein the information indicating the type of the face indicates a rectangle when the projection format for the projected picture indicates cubic projection.

9. The 360-degree video data processing method according to claim 7, wherein the information indicating the type of the face indicates a triangle when the projection format for the projected picture indicates octahedral projection.

10. The 360-degree video data processing method according to claim 1, wherein the metadata includes region information on the region, and the region information indicates an x-coordinate value and a y-coordinate value of the top-left pixel of the region on the packed picture associated with a face according to a projection format.

11. The 360 video-degree data processing method according to claim 10, wherein the region information further indicates the width and the height of the region on the packed picture.

12. The 360-degree video data processing method according to claim 11, wherein the region information includes a rotation flag indicating whether the region is rotated, and the region information further indicates a rotation reference axis and a rotated angle when the rotation flag is 1.

13. The 360-degree video data processing method according to claim 12, wherein the metadata includes a region information flag indicating presence or absence of the region information, and the metadata includes the region information when the region information flag indicates presence of the region information.

14. A 360-degree video data processing method performed by a 360 video reception apparatus, comprising:
receiving a signal including information on a packed picture with respect to 360-degree video data and metadata with respect to the 360-degree video data;
acquiring the information on the packed picture and the metadata by processing the signal;
decoding the packed picture on the basis of the information on the packed picture; and
rendering the decoded picture on a 3D space by processing the decoded picture on the basis of the metadata,
wherein the metadata includes 3D mapping information on a region of the packed picture, and the 3D mapping information indicates a yaw value and a pitch value of spherical coordinates of a spherical surface corresponding to a center point of the region.

15. The 360-degree video data processing method according to claim 14, wherein the 3D mapping information further indicates a yaw range and a pitch range of a region on the spherical surface corresponding to the region.

16. The 360-degree video data processing method according to claim 14, wherein the 3D mapping information further indicates a maximum yaw value, a minimum yaw value, a maximum pitch value and a minimum pitch value of the region on the spherical surface corresponding to the region.

17. The 360-degree video data processing method according to claim 15, wherein the metadata includes a 3D mapping information flag indicating presence or absence of the 3D mapping information, and the metadata includes the 3D mapping information when the 3D mapping information flag indicates presence of the 3D mapping information.

18. The 360-degree video data processing method according to claim 14, wherein the metadata includes a packing application flag indicating whether the region-wise packing is applied, and the metadata includes information about an x-coordinate value and a y-coordinate value of the top-left pixel of the region on the projected picture when the packing application flag indicates that the region-wise packing is applied to the region.

19. The 360-degree video data processing method according to claim 18, wherein the metadata further includes information about the width and the height of the region on the projected picture.

20. A 360 video transmission apparatus comprising:
a data input unit for acquiring 360 video data captured by at least one camera;
a projection processor for acquiring a projected picture by processing the 360 video data;
a region-wise packing processor for acquiring a packed picture by applying region-wise packing to the projected picture;
a metadata processor for generating metadata for the 360 video data;
a data encoder for encoding the packed picture; and
a transmission processor for performing processing for storage or transmission on the encoded picture and the metadata,
wherein the metadata includes 3D mapping information on a region of the packed picture, and the 3D mapping information indicates a yaw value and a pitch value of spherical coordinates of a spherical surface corresponding to a center point of the region.
